(19) United States
(12) Patent Application Publication
(10) Pub. No.: US 2016/0357846 A1
(43) Pub. Date: Dec. 8, 2016

(54) DATA CLASSIFICATION APPARATUS, NON-TRANSITORY COMPUTER-READABLE RECORDING MEDIUM STORING PROGRAM FOR DATA CLASSIFICATION, AND DATA CLASSIFICATION METHOD

(71) Applicant: FUJITSU LIMITED, Kawasaki-shi (JP)

(72) Inventor: Koji MARUHASHI, Hachioji (JP)

(73) Assignee: FUJITSU LIMITED, Kawasaki-shi (JP)

(21) Appl. No.: 15/166,945

(22) Filed: May 27, 2016

(30) Foreign Application Priority Data
Jun. 2, 2015 (JP) 2015-112285

(51) Int. Cl. G06F 17/30

(52) U.S. Cl. CPC G06F 17/30598

(57) ABSTRACT

A data classification apparatus includes an acquisition section for acquiring data including records; a classification section for classifying the records, wherein the classification section generates groups in which each of the records is arranged, calculates a first and a second evaluation values, determines whether or not to rearrange the first record based on the first and the second evaluation values, and performs rearrangement of the first record when it is determined that the first record is to be rearranged, the first evaluation value being based on an arrangement status of the records when a first record arranged in a first group in the groups is rearranged into a second group not included in the groups and the second evaluation value based on an arrangement status of the records when each record arranged in the first group is rearranged into either the first group or the second group.

### CROSS-REFERENCE TO RELATED APPLICATION

This application is based upon and claims the benefit of priority of the prior Japanese Patent Application No. 2015-112285, filed on Jun. 2, 2015, the entire contents of which are incorporated herein by reference.

### FIELD

The embodiments discussed herein are related to a data classification apparatus, a non-transitory computer-readable recording medium storing program for data classification, and a data classification method.

### BACKGROUND

Various methods (for example, collectivization and clustering) for classifying so-called discrete data into various collections (hereinafter, also referred to as groups), have been suggested. For example, discrete data includes Point of Sale system (POS) records including identifiers (IDs), World Wide Web (WEB) access log records, and the like.

Analysts of discrete data analyze classified discrete data (for example, records of various collections) with the object of inferring the intentions and behavior of people. For example, such analysts analyze classified discrete data with the object of inferring purchasing behavior based on shared consumer needs, and the object of inferring WEB browsing behavior based on shared interests.

As a method of the classification of discrete data, there is a method that classifies discrete data by referring to an evaluation value of a collection, which is calculated based on an event probability (hereinafter, also referred to as an occurrence probability) of a record within a collection, and a constant factor of a collection quantity.

“Daniel Barbara, Yi Li, Julia Couto.; COOLCAT: An Entropy-based Algorithm for Categorical Clustering; CIKM 2002: 582-589” is an example of the related art.

### SUMMARY

According to an aspect of the invention, a data classification apparatus includes a memory that stores a plurality of records, and a processor configured to acquire data including the plurality of records, each of the plurality of records including a plurality of types of variable values, generate a plurality of groups in which each of the plurality of records included in the acquired data is arranged, calculate a first evaluation value and a second evaluation value, the first evaluation value being calculated based on an arrangement status of the plurality of records when a first record arranged in a first group included in the plurality of groups is rearranged into a second group which is a new group that is not included in the plurality of groups, and the second evaluation value being calculated based on an arrangement status of the plurality of records when each record that is arranged in the first group is rearranged into either the first group or the second group, determine whether or not to rearrange the first record based on the first evaluation value and the second evaluation value, and rearrange the first record in a case in which it is determined that the first record is to be rearranged.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1C are diagrams that describe records that are included in discrete data;

FIG. 2 is an example of discrete data, and an example of a collection configuration table that illustrates records within collections, and the like, of a case in which the discrete data is classified using a method;

FIG. 3 is a flowchart that describes a flow of a process of the method of classification of the discrete data;

FIG. 4 is a diagram that illustrates a collection configuration table which illustrates an initial collection;

FIG. 5 is a first diagram that illustrates a collection configuration table after rearrangement;

FIG. 6 is a second diagram that illustrates a collection configuration table after rearrangement;

FIG. 7 is a first diagram that describes a technical problem of the method;

FIG. 8 is a second diagram that describes a technical problem of the method;

FIG. 9 is a hardware block diagram of a data classification apparatus of the present embodiment;

FIG. 10 is a software block diagram of the data classification apparatus of FIG. 9;

FIGS. 11A and 11B are flowcharts that describe a flow of a classification process of discrete data in the present embodiment;

FIG. 12 is a flowchart that describes a flow of a process of Step S3 in FIG. 11A;

FIG. 13 is a first diagram that describes a specific example in the present embodiment;

FIG. 14 is a second diagram that describes a specific example in the present embodiment;

FIG. 15 is a third diagram that describes a specific example in the present embodiment;

FIG. 16 is a fourth diagram that describes a specific example in the present embodiment;

FIG. 17 is a fifth diagram that describes a specific example in the present embodiment;

FIG. 18 is a sixth diagram that describes a specific example in the present embodiment;

FIG. 19 is a seventh diagram that describes a specific example in the present embodiment;

FIG. 20 is an eighth diagram that describes a specific example in the present embodiment;

FIG. 21 is a ninth diagram that describes a specific example in the present embodiment;

FIG. 22 is a tenth diagram that describes a specific example in the present embodiment;

FIG. 23 is an eleventh diagram that describes a specific example in the present embodiment;

FIG. 24 is a twelfth diagram that describes a specific example in the present embodiment;

FIG. 25 is a thirteenth diagram that describes a specific example in the present embodiment; and

FIG. 26 is a fourteenth diagram that describes a specific example in the present embodiment.

### DESCRIPTION OF EMBODIMENTS

However, in the suggested classification method of discrete data described in the background, for example, the evaluation value described in the background is calculated based on the event probability of a record, and the constant factor of the collection quantity. Therefore, there are cases in which it is difficult to classify discrete data into collections (groups) from which it is possible for analysts to easily achieve the object.

Accordingly, it is desired to provide a data classification apparatus, a data classification program, and a data classification method that may classify discrete data into groups according to an object.

<Records Included in Discrete Data>

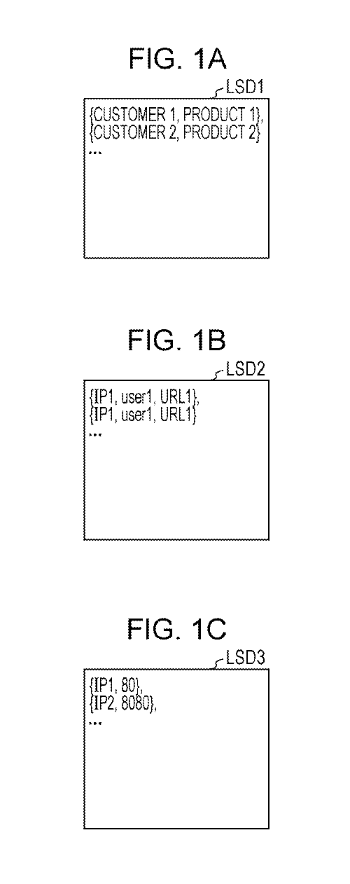

FIGS. 1A to 1C are diagrams that describe records that are included in discrete data. In the following drawings “ . . . ” indicates an omission.

FIG. 1A is a diagram that illustrates discrete data LSD1, which includes POS records including IDs. The POS records including IDs include two types of variable value. The first type of variable value is a customer ID that uniquely identifies a customer. The second type of variable value is a product ID that uniquely identifies a product. In FIG. 1A, a single record is indicated as “{Customer ID, Product ID}”. Further, each record is partitioned by a comma between the curly brackets. In FIG. 1A, for example, the record of {customer1,product1} includes “customer1” as the Customer ID, and “product1” as the Product ID.

FIG. 1B is a diagram that illustrates discrete data LSD2, which includes WEB access log records. The WEB access log records include three types of variable value. The first type of variable value is an IP address of an access destination server. The second type of variable value is a user ID that uniquely identifies an end-user that accessed the server. The third type of variable value is a Uniform Resource Locator (URL) that was accessed.

In FIG. 1B, a single record is indicated as “{IP Address, User ID, URL}”. Further, each record is partitioned by a comma between the curly brackets. In FIG. 1B, for example, the record of {IP1,user1,URL1} includes “IP1” as the IP address, “user1” as the User ID, and “URL1” as the URL.

FIG. 1C is a diagram that illustrates discrete data LSD3, which includes network traffic log records (hereinafter, also referred to as traffic logs). In a case of communicating between devices using the Transmission Control Protocol (TCP)/Internet Protocol (IP) protocol, the traffic logs include a transmission destination IP address, and a transmission destination port number, which are included in communication packets that are sent and received between the devices.

The traffic log records include two types of variable value. The first type of variable value is a transmission destination IP address. The second type of variable value is a transmission destination port number.

In FIG. 1C, a single record is indicated as {Transmission Destination IP Address, Transmission Destination Port number}. Further, each record is partitioned by a comma between the curly brackets. In FIG. 1C, for example, the record of {IP1,80} includes “IP1” as the IP address, and “80” as the port number.

The number of records that are included in discrete data is, for example, from hundreds of thousands to tens of millions. The types of variable value (hereinafter, also referred to as the number of variable values) that are included in records, is for example, 2 to 10. The range of the allowable value of each variable is, for example, thousands to tens of thousands.

<Method of Classification of Discrete Data>

A method of classification of discrete data (hereinafter, also simply referred to as a method) will be described. The discrete data is classified by the method so that there is little variation in the variable values of records within collections in a case of classifying a plurality of records that are included in discrete data. Additionally, the meaning of classifying a plurality of records that are included in discrete data is the same as that of classifying discrete data.

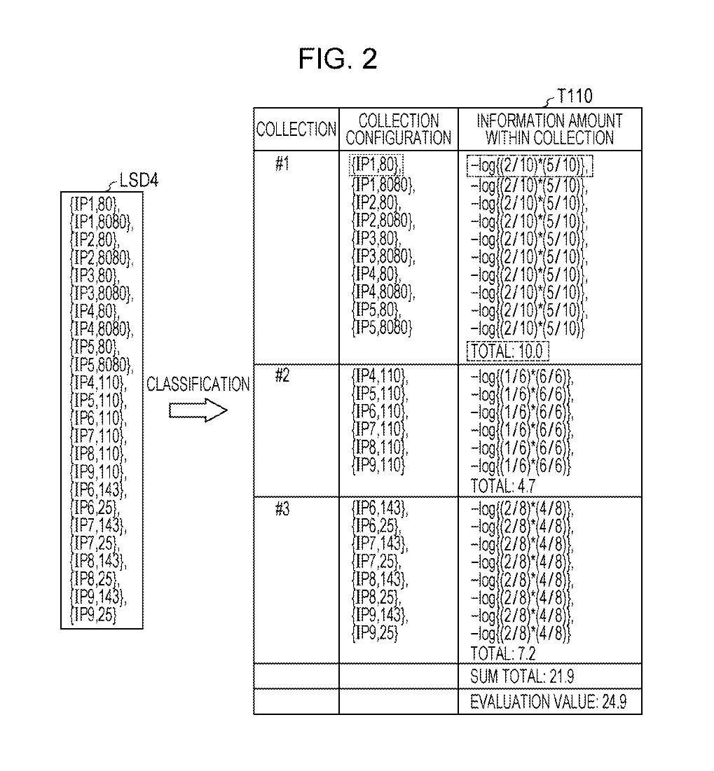

For example, in a case of classifying discrete data, the method classifies discrete data so that there are few rare variable values among variable values within collections. The method will be described with reference to FIGS. 2 to 6.

FIG. 2 is an example of discrete data, and an example of a collection configuration table that illustrates records within collections, and the like, of a case in which the discrete data is classified using a method.

Discrete data LSD4 is an example of discrete data that includes the traffic log records that were described in FIG. 1C. In the following description, for the convenience of explanation, the number of records that is included in the discrete data LSD4, which is a target of classification, is set as 24.

A collection configuration table T110 is a table that indicates a configuration of classified records (hereinafter, also referred to as a collection configuration of records). The collection configuration table T110 includes a collection column, a collection configuration column, and an information amount within collection column. The collection column stores collection identifiers that uniquely identify collections that includes one or more records. The collection identifiers are, for example, indicated as “#k” (lower case character k is an integer of 1 or more).

The collection configuration column is a column that stores records that belong to collections, which are identified by the collection identifiers. Additionally, the meaning of records that belong to collections is the same as that of records within collections, and records that are included in collections. The information amount within collection column stores information amounts within collection of the records that are stored in the collection configuration column.

The information amounts within collection are logarithms of the inverses of the occurrence probabilities (event probabilities) of each record within the collections. Additionally, for example, the logarithms are base 10 common logarithms. The occurrence probability of a record is the product of the respective occurrence probabilities in a collection of the variable values, which are included in records that belong to the collection to which the record belongs. The respective occurrence probabilities of the variable values are values obtained by dividing the number of identical variable values that are included in one or more records that belong to a certain collection (hereinafter, also referred to as a collection X) by the number of records that belong to the collection X.

In FIG. 2, the information amount within collection of the record {IP1,80}, which belongs to a first collection #1 is calculated. In the records of the first collection #1, the number of variable values identical to the first type of variable value IP1 in the record {IP1,80} is 2 (refer to records {IP1,80} and {IP1,8080}). In the records of the first collection #1, the number of variable values identical to the second type of variable value 80 in the record {IP1,80} is 5 (refer to records {IP1,80}, {IP2,80}, {IP3,80}, {IP4,80} and {IP5,80}). Further, the total of records, which belong to the first collection #1, is 10.

Accordingly, the occurrence probability of identical variable values IP1 is 2/10. Further, the occurrence probability of identical variable values 80 is 5/10. Accordingly, the information amount within collection of the record {IP1,80} in the first collection #1 is −log {(2/10)*(5/10)} (refer to the text within the dashed-dotted line border in FIG. 2). Additionally, the “/” and the “*” in the logarithm (log) in the information amount within collection indicates division and multiplication, respectively. Additionally, the occurrence probability of a record is also referred to as the joint probability of a value.

In FIG. 2, the information amount within collection of a certain record (hereinafter, also referred to as a record X) is an information amount within collection (hereinafter, also referred to as an information amount within collection X) that is stored in the same row of the collection configuration column as the row (horizontal position) in which the record X is stored. For example, in a case in which the record X is the record {IP1,80} in the first collection #1 (refer to the text within the dotted line border in FIG. 2), the information amount within collection X of the record X is −log {(2/10)*(5/10)} in the first collection #1 (refer to text within the dashed-dotted line border in FIG. 2).

The total of the information amount within collection of each record that belongs to a kth (lower case k is an integer of 1 or more) collection #k is indicated at the bottom of a cell in which each record is stored. For example, the total of the information amount within collection of each record that belongs to the first collection #1 is “10.0”. The reason for this that the sum total of each record that belongs to the first collection #1, is 10. In addition, the information amount within collection of each record that belongs to the first collection #1 is −log {(2/10)*(5/10)}, that is, “1”. Accordingly, the total of the information amount within collection of each record that belongs to the first collection #1 is “10.0” (refer to text within the broken line border in FIG. 2)

In the collection configuration table T110, a cell in which the second row from the bottom and the information amount within collection column intersect, stores a sum total of the information amount within collection of each record in each collection. For example, the totals of the information amount within collection of each record in the first collection #1 to the third collection #3 are respectively “10.0”, “4.7” and “7.2”. Accordingly, the above-mentioned sum total is “21.9”.

In the collection configuration table T110, an evaluation value of the collection configuration is stored in a cell in which the first row from the bottom and the information amount within collection column intersect. The evaluation value of the collection configuration in the method is a total of the sum total of the information amounts within collection and a constant multiplication of the number of collections. In this instance, the constant factor is set as 1. In the example of the collection configuration table T110, since the table is divided into three collections (the first collection #1 to the third collection #3), the number of collections is 3. Therefore, the constant factor of the number of collections is 3. Accordingly, the evaluation value of the collection configuration is 24.9 (21.9+3.0).

<Flowchart of Method of Classification of Discrete Data>

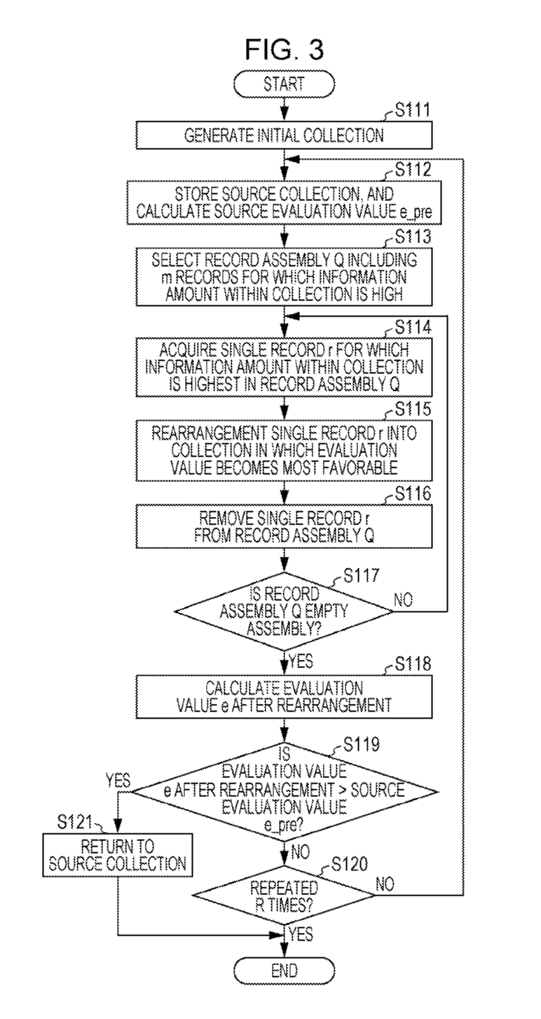

FIG. 3 is a flowchart that describes a flow of a process of the method of classification of the discrete data. Additionally, in the flowchart, “Ss” (lower case s is an integer of 1 or more) indicates Step Ss.

Step S111: The method generates initial collections. More specifically, the method selects k (lower case k is an integer of 1 or more) records for which there is little mutual commonness of variable values from records that are included in discrete data, which is a target of the classification process, as non-regulation (that is, random), and creates k collections, which include a single selected record each.

Each of these selected records is a record that corresponds to a core of a collection (hereinafter, also referred to as a seed of collection). Thereafter, the method adds records similar to the records as the cores to the collections including the records that correspond to the cores. More specifically, the method generates k initial collections by sequentially arranging records other than the k records from the records that are included in the discrete data, which is a target of the classification process, into the k collections so that the evaluation value is as favorable as possible.

Step S112: The method stores the source collections, and calculates a source evaluation value e_pre of the collections. In a case of executing S112 for the first time, the source collections are the initial collections (S111). In a case of executing S112 for a second time and onward, the source collections are collections after S115 is finished. Additionally, for example, the method stores the collections in the form of a collection configuration table.

Step S113: The method selects a record assembly Q, which includes m (m is an integer of 1 or more) items of data for which the information amount within collection is high.

Step S114: The method acquires a single record r for which the information amount within collection is the largest in the record assembly Q.

Step S115: The method rearranges the single acquired record r into a collection in which the evaluation value becomes the most favorable. In this instance, the meaning of the evaluation value being most favorable is the same as that of the evaluation value being the lowest.

Step S116: The method removes the single record r from the record assembly Q.

Step S117: The method determines whether or not the record assembly Q is an empty assembly. In a case in which the record assembly Q is not an empty assembly (NO in S117), the process moves to S114. In a case in which the record assembly Q is an empty assembly (YES in S117), the process moves to S118.

Step S118: The method calculates an evaluation value e after rearrangement.

Step S119: The method determines whether or not the evaluation value e after rearrangement exceeds the source evaluation value e_pre. In a case in which the evaluation value e after rearrangement does not exceed the source evaluation value e_pre (NO in S119), the process moves to S120. In a case in which the evaluation value e after rearrangement exceeds the source evaluation value e_pre (YES in S119), the process moves to S121.

Step S120: The method determines whether or not the steps of S112 to S113 have been repeated R times. In a case in which the steps of S112 to S113 have been repeated R times (YES in S120), the process is finished. The method sets the collections after rearrangement at the time that the process is finished as discrete data collections after classification. In a case in which the steps of S112 to S113 have not been repeated R times (NO in S120), the process moves to S112.

Step S121: The method returns the record r that was rearranged in S115 to the source collection thereof, and sets the collections before rearrangement as discrete data collections after classification.

<Specific Example of Classification of Discrete Data>

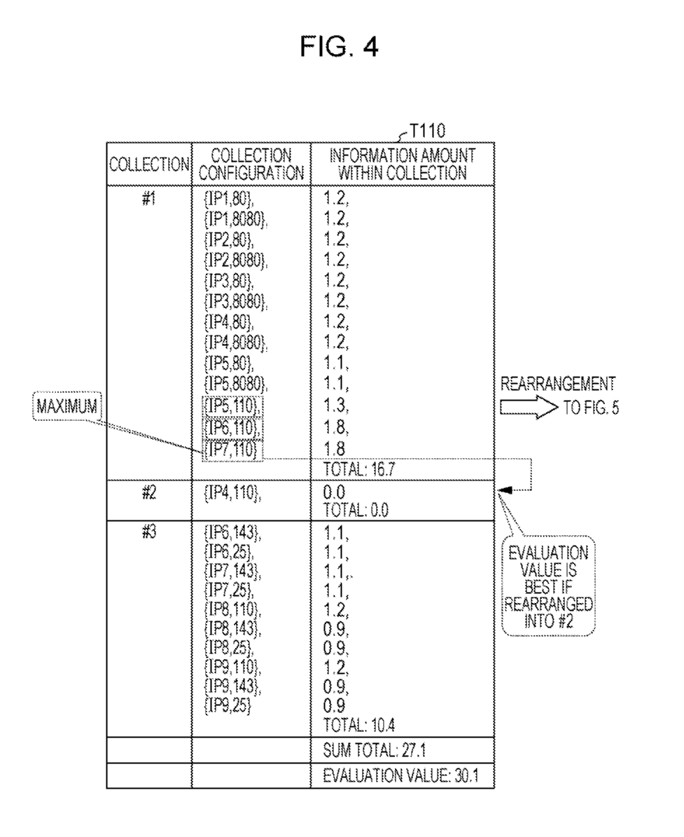

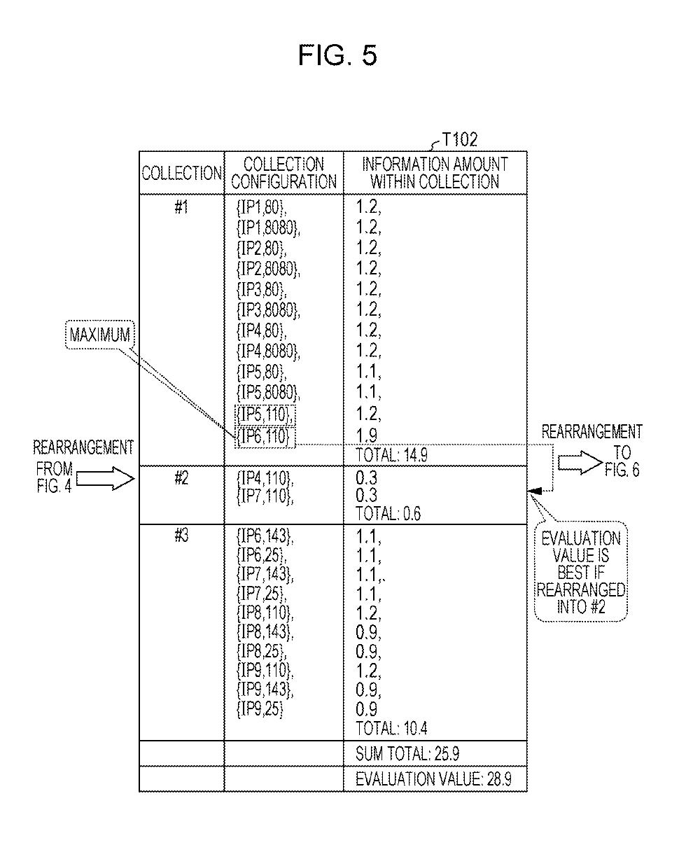

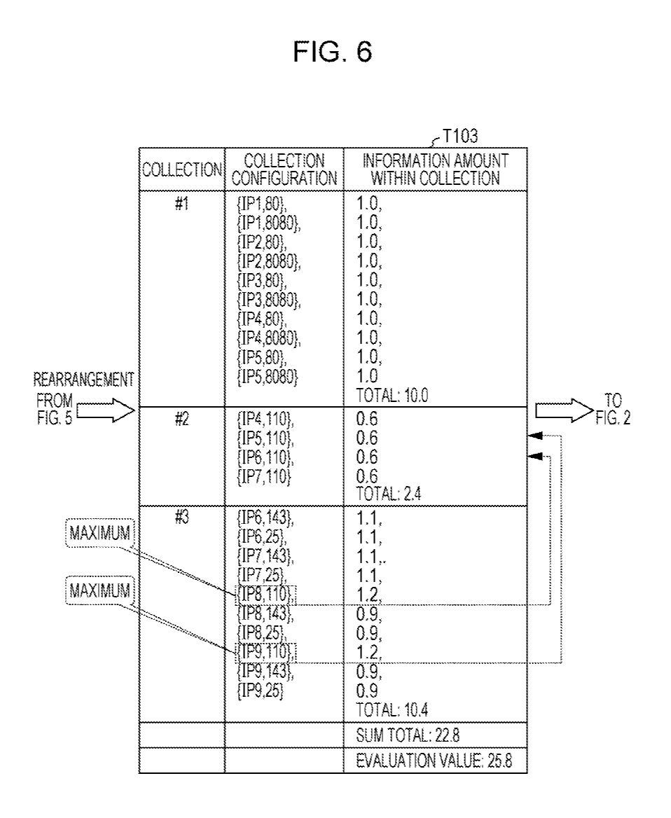

A specific example of the method of classification of discrete data will be described with reference to FIGS. 2 to 6. FIG. 4 is a diagram that illustrates a collection configuration table which illustrates an initial collection. FIGS. 5 and 6 are a first and second diagram that illustrate collection configuration tables after rearrangement. Additionally, the collection configuration tables of FIGS. 4 to 6 include the same configuration as the collection configuration table T110 in FIG. 2. However, the information amounts within collection of the collection configuration tables of FIGS. 4 to 6 are illustrated as numerical values instead of formulae for the convenience of description.

The method randomly selects k records (for example, k is 3) for which there is little mutual commonness of variable values from records that are included in discrete data, which is a target of the classification process to create k collections which include a single selected record each. The method selects three records (for example, {IP1,80}, {IP4,110} and {IP6,143}) from the records that are included in the discrete data LSD4 in FIG. 2, and creates three collections. Further, as illustrated in S111 in FIG. 3, the method generates initial collections by sequentially arranging records other than the three records from the records that are included in the discrete data LSD4, which is a target of the classification process, in the three collections so that the evaluation value is as favorable as possible.

The method stores a collection configuration table T101, which is the source collections, and calculates the source evaluation value e_pre of the collections (S112). As illustrated in FIG. 4, the source evaluation value of the collections is 30.1.

The method selects a record assembly Q, which includes m (m is 3 in this step) items of data for which the information amount within collection is high_(S113). Additionally, the method may change “m” as appropriate for each step. In the example of FIG. 4, the method selects the records {IP6,110} and {IP7,110} for which the information amount within collection is 1.8, and the record {IP5,110} for which the information amount within collection is 1.3, where the records {IP6,110}, {IP7,110}, and {IP5,110} are surrounded by the dotted line border.

The method acquires a single record r (for example, {IP7,110}, refer to the “maximum” balloon in FIG. 4) for which the information amount within collection is the highest in the record assembly Q (S114). The method rearranges the acquired record r into a second collection #2 in which the evaluation value becomes most favorable (the evaluation value becomes lowest) as a result of the rearrangement (S115) (refer to “evaluation value is best when rearranged into #2” in FIG. 4).

The method removes the single record r ({IP7,110}) from the record assembly Q (S116).

In FIG. 5, a collection configuration table T102 in which the record r ({IP7,110}) is rearranged into the second collection #2, is illustrated. Additionally, as illustrated in FIG. 5, the method updates the information amount within collection after rearrangement (refer to S115).

Since the record assembly Q is not an empty assembly (NO in S117), the process moves to S114. The method acquires a single record r (for example, {IP6,110}, refer to the “maximum” balloon in FIG. 5) for which the information amount within collection is the highest in the record assembly Q which includes {IP5,110} and {IP6,110} (S114). The method rearranges the acquired record r into the second collection #2 in which the evaluation value becomes most favorable as a result of the rearrangement (S115) (refer to “evaluation value is best when rearranged into #2” in FIG. 5).

The method removes the single record r ({IP6,110}) from the record assembly Q (S116). Thereafter, the method performs the processes of S117 and S114 to S116 for the record assembly Q, rearranges the record {IP5,110}, which is included in the record assembly Q, into the second collections #2 and removes the record {IP5,110} from the record assembly Q.

In FIG. 6, a collection configuration table T103 in which all of the records ({IP5,110}, {IP6,110} and {IP7,110}) of the record assembly Q are rearranged into the second collection #2, is illustrated. When the record assembly Q becomes an empty assembly (YES in S117), the method calculates the evaluation value e after rearrangement (S118). As illustrated in the collection configuration table T103 of FIG. 6, the evaluation value after rearrangement is “25.8”.

Since the evaluation value e after rearrangement does not exceed the source evaluation value e_pre (S119), the method determines whether or not the steps of S112 to S113 have been repeated R times (for example, two times) (S120). In the above-mentioned example, since the steps of S112 to S113 have been repeated one time (NO in S120), the process moves to S112.

The method stores the collection configuration table T103, which is the source collections, and calculates the source evaluation value e_pre of the collections (S112). As illustrated in FIG. 6, the source evaluation value of the collections is 25.8.

The method selects a record assembly Q, which includes m (m is 2 in this step) records for which the information amount within collection is high (S113). In the example of FIG. 6, the method selects the records {IP8,110} and {IP9,110} for which the information amount within collection is 1.2 (refer to the dotted line borders and the “maximum” balloons in FIG. 6). Thereafter, the method performs repetition of the processes of S114 to S117, and rearranges the records {IP8,110} and {IP9,110} into the second collection #2. The collection configuration table after this rearrangement is the collection configuration table T110 of FIG. 2.

Further, when the record assembly Q becomes an empty assembly (YES in S117), the method calculates the evaluation value e after rearrangement (S118). As illustrated in FIG. 2, the evaluation value after rearrangement is “24.9”. Additionally, in FIG. 2, the information amounts within collection are indicated with formulae, and statement of the numerical values is omitted.

Since the evaluation value e after rearrangement does not exceed the source evaluation value e_pre (NO in S119), the method determines whether or not the steps of S112 to S113 have been repeated R times (for example, two times) (S120). In the above-mentioned example, since the steps of S112 to S113 have been repeated two times (YES in S120), the process is finished.

Due to the method, as illustrated in FIG. 2, as a result of classifying the discrete data LSD4, the plurality of records that are included in the discrete data LSD4 are classified into the first collection #1 to the third collection #3. Analysts of discrete data may infer the intentions and behavior of people by referring to the classified records.

<Technical Problem of Method of Classification of Discrete Data>

A technical problem of the method will be described. Optimum collections that may achieve the object of analysts of discrete data differ depending on the contents of the records that are included in the discrete data. These optimum collections are collections that depend on the object of the analysts. That is, it is preferable to change the method of classification in order to achieve the object of the analysts. For example, the discrete data LSD4 that is described in FIG. 2 includes traffic log records. In a case of classifying discrete data that includes such records, in addition to just the sum total of the information amounts within collection, it is preferable to take other factors (for example, the shared count, which will be described below).

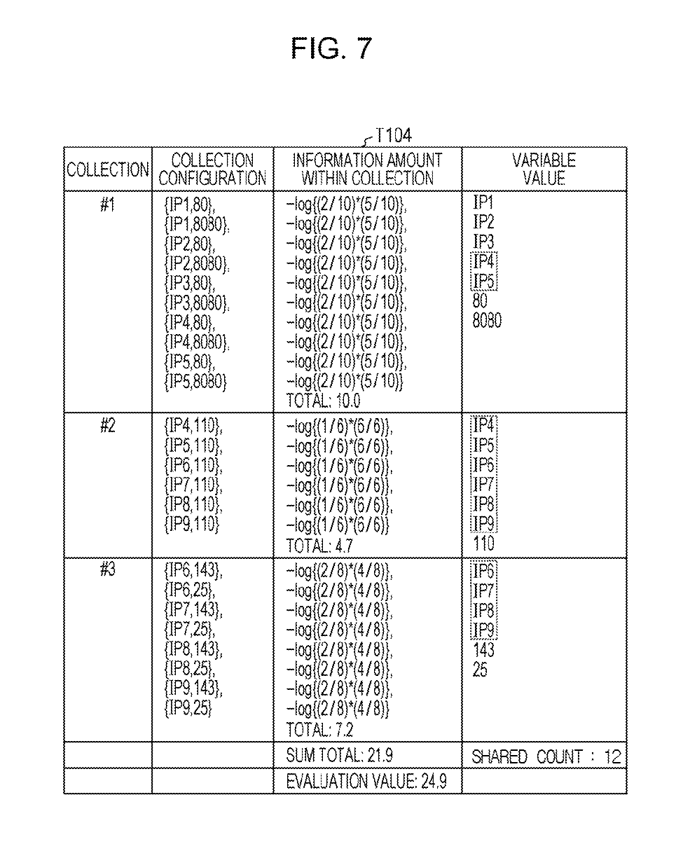

FIG. 7 is a first diagram that describes a technical problem of the method. A collection configuration table T104 of FIG. 7 is a table in which a variable value column has been added to the right column of the collection configuration table T110 of FIG. 2.

The variable value column stores variable values of the records that are stored in the collection configuration column. For example, the variable values of the records that are stored in the collection configuration column in the first collection #1 are IP1, IP2, IP3, IP4, IP5, 80, and 8080. Accordingly, these variable values IP1, IP2, IP3, IP4, IP5, 80, and 8080 are stored in a cell in which the row in which the collection identifier “#1” of the first collection #1 is stored, and the variable value column intersect.

In the collection configuration table T104, a cell in which the second row from the bottom and the variable value column intersect, is a cell that stores a shared count. The shared count indicates a sum quantity of identical variable values in a case in which different collections share identical variable values. For example, the identical variable values IP4 and IP5 are common to the different first collection #1 and second collection #2. Identical variable values that are common to different collections are indicated with a dotted line border. In the case of the example of FIG. 7, the sum quantity of the variable values inside the dotted line borders is the shared count, and the shared count is 12.

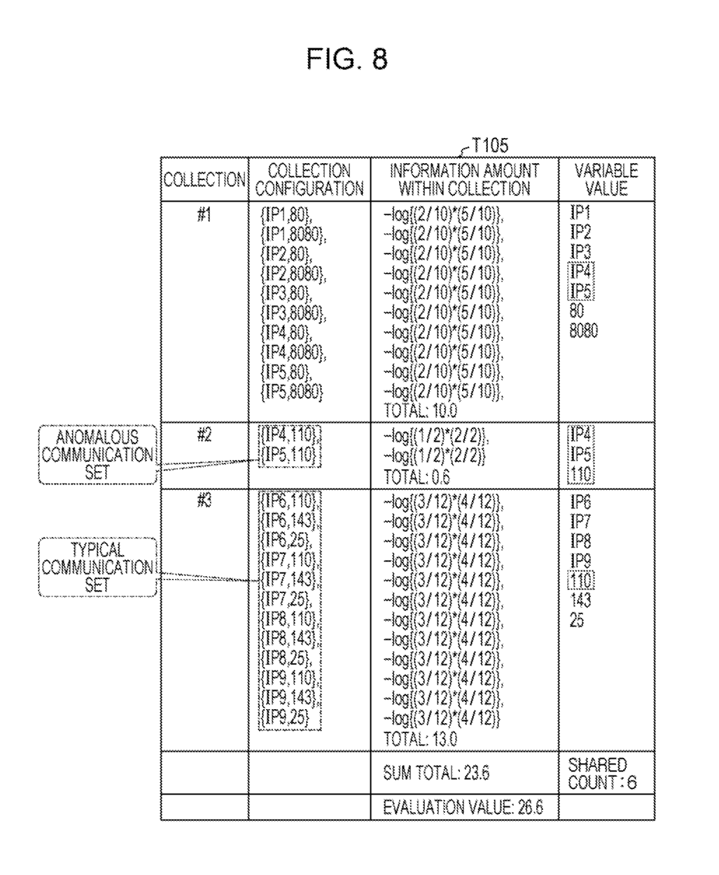

FIG. 8 is a second diagram that describes a technical problem of the method. A collection configuration table T105 of FIG. 8 includes the same configuration as the collection configuration table T104 of FIG. 7. The collection configuration table T105 indicates a collection configuration table in which the discrete data LSD4 is classified using a technique that differs from the method.

In the collection configuration table T105 of FIG. 8, the records {IP6,110}, {IP7,110}, {IP8,110}, and {IP9,110} of the second collection #2 in the collection configuration table T104 of FIG. 7, are arranged in the third collection #3. In the same manner as FIG. 7, in FIG. 8, identical variable values that are common to different collections are also indicated with a dotted line border. In the case of the example of FIG. 8, the number of variable values inside the dotted line borders is the shared count, and the shared count is 6. In the example of FIG. 8, the identical variable values IP4 and IP5 are common to the different first collection #1 and second collection #2, and the identical variable value 110 is common to the different second collection #2 and third collection #3.

In FIG. 8, the records {IP4,80}, {IP4,8080}, {IP5,80} and {IP5,8080} that belong to the first collection #1, and the records {IP4,110} and {IP5,110} that belong to the second collection #2 will be focused on. In this instance, a first server in which the IP address IP4 is set, is a WEB server, and a second server in which the IP address IP5 is set, is a WEB server. In this manner, the first and second servers are WEB servers, and are not mail servers.

In this instance, for example, a mail server that performs the distribution of electronic mail uses characteristic port numbers 25, 110 and 143. The port number 25 is a port number of SMTP, the port number 110 is a port number of POP3, and the port number 143 is a port number of IMAP4. Additionally, SMTP is an abbreviation for “Simple Mail Transfer Protocol”, POP is an abbreviation for “Post Office Protocol”, and IMAP is an abbreviation for “Internet Message Access Protocol”.

However, according to the records {IP4,110} and {IP5,110} that belong to the second collection #2, it may be understood that TCP/IP packets, in which the port numbers 110 of the first and second servers, which are web servers, are set as transmission destination port numbers, are being transmitted. A server that executes communication by using (opening) the port number 110 is a mail server. However, the first and second servers in which the IP addresses IP4 and IP5 are set, are WEB servers, and are not mail servers. Therefore, there is a high probability that communication using such TCP/IP packets is communication with an object of port scanning or attacking a specific port. Additionally, hereinafter, communication using such TCP/IP packets will also be referred to as an anomalous communication set.

That is, there is a high probability that the records ({IP4,110} and {IP5,110}) of such TCP/IP packets are collections of records that are generated as a result of behavior that is based on anomalous intentions such as intentions that attempt to carry out dishonest acts.

In a case in which analysts of discrete data analyze classified discrete data with an object of detecting behavior that is based on such anomalous intentions, it is easy to detect such behavior when the generated records are classified (collectivized) using behavior that is based on such anomalous intentions. When the analysts discover such behavior, they may instruct a manager of a network, or the like to take measures that will suppress dishonest acts.

Additionally, in a case of POS including identifiers, regardless of the fact that a purchase has not been made in a practical sense, it is assumed that a salesperson will act as when a purchase has been made and perform operation of a register based on intentions that attempt to carry out dishonest acts. In a case of this assumption, a record with contents that deviate from the contents of POS records that are generated by normal purchase behavior, is created by a POS system. Such a record with deviated contents is also a record that is generated by behavior that is based on anomalous intentions.

Meanwhile, in the method, there are cases in which a collection configuration in which the sum total of the information amount within collection is small is set, and the collections are created for each port number. According to the collection configuration table T104 of FIG. 7 that illustrates collections that are created using the method, the first collection #1 is a collection that includes records that include the port numbers 80 and 8080. Additionally, the port number 80 and 8080 are port numbers for WEB server HyperText Transfer Protocol (HTTP).

The second collection #2 is a collection that includes records that include the port number 110. The third collection #3 is a collection that includes records that include the port numbers 25 and 143.

However, in a case in which discrete data is classified with the object of discovering anomalous communication sets, it is desirable to create record collections in the following manner. That is, record collections that are related to servers that use combinations of characteristic (typical) port numbers are summarised, and record collections that indicate communication sets that deviate from the combinations of characteristic port numbers are set as other record collections. Additionally, the object of discovering anomalous communication sets is included in the object of discovering records that are generated as a result of behavior that is based on anomalous intentions such as the above-mentioned intentions that attempt to carry out dishonest acts.

In the example of FIG. 8, a plurality of records (refer to the “typical communication” balloon) that are surrounded by the dashed-dotted line border and belong to the third collection #3 are a record collection that is related to a server that uses combinations of characteristic port numbers. In addition, in the example of FIG. 8, a plurality of records (refer to the “anomalous communication” balloon) that are surrounded by the dashed-two dotted line and belong to the second collection #2 are a record collection that indicates a deviated communication set. In this manner, as illustrated in FIG. 8, having the record {IP5,110} belong to the second collection #2 corresponds to an optimum collection from which it is possible to achieve the object of the analysts of discovering anomalous communication sets. In addition, as illustrated in FIG. 8, having the records {IP6,110}, {IP7,110}, {IP8,110} and {IP9,110}, which belong to the second collection #2 that is illustrated in FIG. 7, belong to the third collection #3 corresponds to an optimum collection from which it is possible to achieve the object of the analysts of discovering anomalous communication sets.

In the abovementioned manner, in a case in which, for example, the object of the analysts is the object of discovering anomalous communication sets, classifying discrete data using a technique that differs from the method may classify discrete data into optimum collections from which easily it is possible to achieve the object of analysts.

In this instance, when FIG. 7 and FIG. 8 are compared, the sum total of the information amount within collection (23.6) in FIG. 8 is greater than the sum total of the information amount within collection (21.9) in FIG. 7. Additionally, in FIGS. 7 and 8, since the number of collections (3) is the same, the evaluation value (26.6) in FIG. 8, is greater than the evaluation value (24.9) in FIG. 7. However, the shared count (6) in FIG. 8 is smaller than the shared count (12) in FIG. 7.

The total of information amounts within collection of a case of classifying using the other method is greater than the total of information amounts within collection of a case of classifying using the method. However, the shared count of a case of classifying using the other method is less than the common number of a case of classifying using the method (denoted as characterizing feature).

According to the characterizing feature, in a case in which the object of analysts is to detect behavior that is based on anomalous intentions such as intentions that attempt to carry out dishonest acts, it may be understood that it is possible to classify discrete data into optimum collections from which it is easily possible to achieve the object of analysts if the shared count is taken into consideration in addition to just the information amounts within collection. In this classification, when classification is performed so that the shared count is as small as possible, it is possible to classify discrete data into optimum collections.

In addition, in the minimum description length (MDL) principle in information theory, it is known that the sum of the complexity of a model, and error with respect to effective data when the model is represented being small is a favorable description of data. In the classification of discrete data, the model is, for example, equivalent to the collections of records, and the complexity of the model is, for example, equivalent to the number of mutually different variable values within a collection. In addition, the error is equivalent to the occurrence probability, and the information amount within collection of the above-mentioned records.

According to the minimum description length principle, it is thought that it is possible to create optimum collections when there are few mutually different variable values within a collection, that is, when there is little complexity in the model. Making the variable values that belong to a collection small may also be achieved by classifying so that the number of identical variable values (the shared count) that belong to different collections is as small as possible.

### Present Embodiment

In such an instance, the data classification apparatus of the present embodiment classifies or splits a plurality of records into a plurality of collections or a plurality of groups so that a common value that indicates a degree of commonness of the variable values between collections is small. Furthermore, in this classification, the data classification apparatus of the present embodiment classifies the plurality of records into the plurality of collections so that the occurrence probability of a record included in the collection is large. The meaning of the common value that indicates the degree of commonness of the variable values being small is the same as that of the number of the identical variable values that belong to different collections being small.

<Hardware Diagram of Data Classification Apparatus>

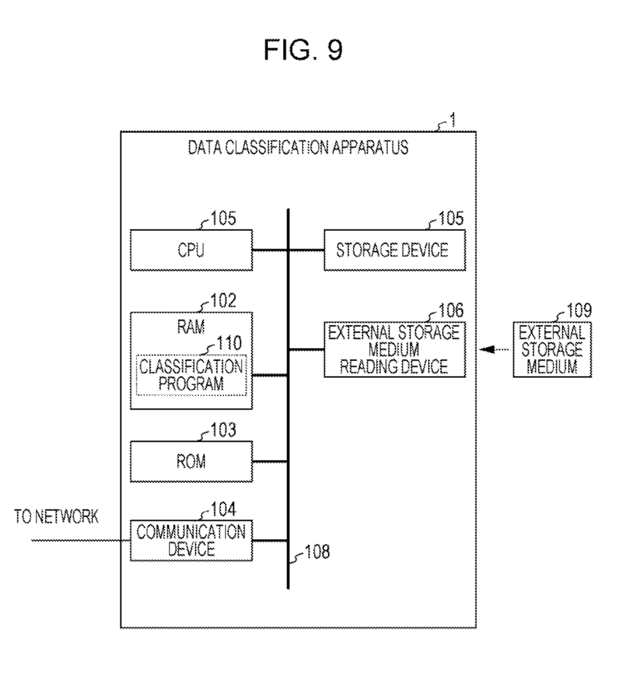

FIG. 9 is a hardware diagram of a data classification apparatus 1 of the present embodiment. The data classification apparatus 1 includes a CPU 101, a RAM 102, a ROM 103, a communication device 104, a storage device 105, and an external storage medium reading device 106, which are connected to a bus 108. For example, the data classification apparatus 1 is an information processing apparatus. Additionally, CPU is an abbreviation for “central processing unit”, RAM is an abbreviation for “random access memory”, and ROM is an abbreviation for “read only memory”.

The CPU 101 is a central computation processing device that performs overall control of the data classification apparatus 1. The RAM 102 temporarily stores processes that the CPU 101 executes, and data, and the like, that is generated (calculated) when a classification program 110 (hereinafter, also simply referred to as a program 110) executes processes. For example, the RAM 102 is semiconductor memory such as dynamic random access memory (DRAM).

The CPU 101 executes the classification program 110 by reading executable files of the classification program 110 from the storage device 105 during activation of the data classification apparatus 1, and developing the executable files in the RAM 102. Additionally, the executable files may be stored in an external storage medium 109.

The ROM 103 stores various items of settings information. The communication device 104 includes a network interface card (NIC), for example, is connected to a network, and executes processes that communicate with other devices. For example, the storage device 105 is a high-capacity storage device such as a hard disk drive (HDD), or a solid state drive (SSD).

The external storage medium reading device 106 is a device that reads data that is stored in the external storage medium 109. The external storage medium 109 is a portable storage medium such as a Compact Disc Read Only Memory (CD-ROM), or a digital versatile disc (DVD), or portable non-volatile memory such as USB memory. For example, the external storage medium 109 stores discrete data, which is a target of the classification process.

<Software Block Diagram of Data Classification Apparatus>

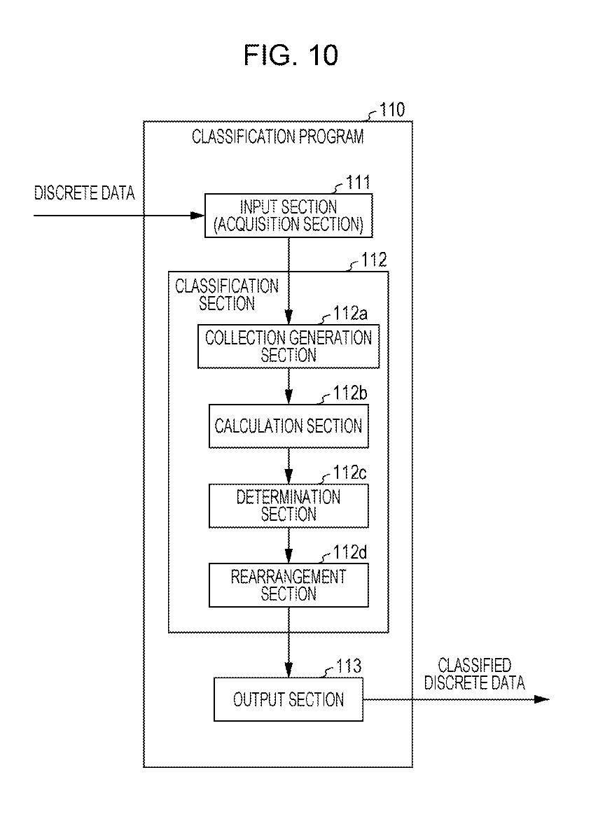

FIG. 10 is a software block diagram of the data classification apparatus 1 of FIG. 9. The classification program 110 includes an input section 111 (hereinafter, also referred to as an acquisition section 111), a classification section 112, and an output section 113.

The input section 111 acquires discrete data from another device or the external storage medium 109, and inputs the discrete data to the classification section 112. The input section 111 is an example of the acquisition section that acquires data (for example, discrete data) that includes a plurality of records, which respectively include various types of variable values. Additionally, other devices are storage servers, and the like that are capable of communicating with the network that the communication device 104 is connected to.

Next, the details of the classification section 112 will be described. The classification section 112 classifies a plurality of records, which are included in discrete data that is acquired by the input section 111, into a plurality of collections (groups). In the classification, for example, the classification section 112 classifies the plurality of records into a plurality of collections based on common values that indicate a degree of commonness of the variable values between collections.

More specifically, for example, the classification section 112 classifies a plurality of records, which are included in the above-mentioned discrete data, into a plurality of collections so that an occurrence probability of a record included in a collection becomes large in the collection, and so that the common values that indicate a degree of commonness of the variable values between collections is small.

In addition, the classification section 112 calculates the occurrence probability of a record based on an occurrence probability in a collection of variable values that are included in records that belong to the collection. More specifically, in the calculation of the occurrence probability of a record, the classification section 112 calculates a product of the respective occurrence probabilities in a collection of variable values that are included in records that belong to a collection, which the record belongs to, and sets a calculated value of the product as the occurrence probability of the record.

Furthermore, the classification section 112 calculates a common value based on the number of identical variable values that belong to different collections and a sum total of mutually different variable values that belong to the respective collections. The common value corresponds to the number of identical variable values (the shared count) that belong to different collections.

According to the above-mentioned method of classification that the classification section 112 executes, as described in FIGS. 7 and 8, classification of discrete data that also takes the shared count into consideration in addition to just the information amount within collection is possible, and as a result of this, it is possible to classify discrete data into optimum collections from which it is possible to easily achieve the object of analysts. That is, according to the above-mentioned method of classification that the classification section 112 executes, it is possible to classify discrete data into groups that depend on the object of analysts. Furthermore, according to the above-mentioned method of classification, since classification is performed so that the number of identical variable values (shared count) that belong to different collections is as small as possible, it is also possible to create optimum collections according to the above-mentioned minimum description length principle.

More specifically, in the classification of a plurality of records, the classification section 112 calculates a total of the inverses of the respective occurrence probabilities of the records. Additionally, the inverses of the occurrence probabilities correspond to the information amounts within collection that were described using FIGS. 2, 7 and 8, and the like.

Furthermore, the classification section 112 calculates the common value for the respective variable values that belong to each collection. Further, the classification section 112 classifies a plurality of records into the plurality of collections so that a sum total of the totals of the inverses of the respective occurrence probabilities of the records, and the totals of the respective common values of the variable values, is small.

The meaning of the sum of the inverses of the respective occurrence probabilities of the records being small is the same as that of the sum of the respective occurrence probabilities of the records being large. Accordingly, when a plurality of records is classified into the plurality of collections so that a sum total of the sum of the inverses of the respective occurrence probabilities of the records and the sum of the respective common values of the variable values, is small, classification of discrete data that also takes the shared count into consideration in addition to just the information amounts within collection, is possible. Accordingly, it is possible to classify discrete data into the above-mentioned optimum collections.

Additionally, the calculation of the logarithms of the inverses of the occurrence probabilities and the logarithms of the common values may be performed in the same way as the calculation of a certain information amount such as entropy by the use of logarithms of inverses of probabilities in information theory.

Next, description of a specific example of the classification section 112 will be performed. The classification section 112 includes a collection generation section 112a (hereinafter, also simply referred to as the generation section 112a) that generates the initial collections that were described using S111 in FIG. 3. In addition, the classification section 112 includes a rearrangement section 112d. The rearrangement section 112d performs rearrangement of records that belong to the initial collections so that an occurrence probability in a collection of records that are included in records that belong to each collection is large, and so that the common value that indicates a degree of commonness of the variable values between collections is small. That is, the classification section 112 classifies a plurality of records that are included in discrete data by performing rearrangement of the records that belong to the initial collections, which the collection generation section 112a generates.

Furthermore, the classification section 112 includes a calculation section 112b and a determination section 112c for determining whether or not each record is a record for which rearrangement has to be performed when the rearrangement section 112d performs rearrangement of the records. More specifically, the calculation section 112b calculates evaluation values that are based on a record classification status (hereinafter, also referred to as a record arrangement status or an arrangement status of records) in a case in which it is assumed that rearrangement of a certain record is being performed. Further, the determination section 112c performs determination of whether or not rearrangement of the record has to be performed based on the evaluation value that the calculation section 112b calculates. That is, the determination section 112c determines whether or not the rearrangement of the record will be effective before performing the rearrangement of the record so that the classification of each record is performed efficiently. Additionally, records for which the determination section 112c has determined that rearrangement has to be performed are also referred to as effective records. Hereinafter, description of the detailed function of each section will be given.

The collection generation section 112a generates the initial collections that were described using S111 in FIG. 3. More specifically, the collection generation section 112a randomly selects k records from a plurality of records included in discrete data acquired by the input section 111 to generate k collections so that there are few common variable values among the k records, where k is an integer of two or more. The collection generation section 112a arranges records of the plurality of records other than the k records into the k collections so that the occurrence probabilities of the records included in a collection is increased by arranging the record. Additionally, k may be indicated as Na. As a result of the generation of the initial collections, discrete data is classified so that the occurrence probability in a collection of a record included in records that belong to the collection increases.

Additionally, in the calculation of the occurrence probability of a record, for example, the collection generation section 112a calculates a product of the respective occurrence probabilities of variable values included in the record with respect to a collection which includes the record and sets a calculated value of the product as the occurrence probability of the record.

The calculation section 112b calculates an evaluation value (hereinafter, also referred to as a first evaluation value) that is based on the arrangement status of each record in a case of rearranging a certain record (hereinafter, also referred to as a first record), which is arranged in a certain collection (hereinafter, also referred to as a first collection or a first group) that is included in a plurality of collections, into a certain collection that is not included in a plurality of collections (hereinafter, also referred to as a second collection or a second group).

More specifically, the calculation section 112b calculates the inverse of the occurrence probability of each record for each collection in a case of rearranging the first record into the second collection. In addition, in this case, the calculation section 112b calculates the common value that is based on the number of collections in which each variable value is included in each collection, and the number of the variable values that are included in any one of the collections (the number of types of variable value) for each variable value. Further, the calculation section 112b calculates the first evaluation value by adding the sum total of the calculated inverses of the occurrence probability of each record, and the sum total of the calculated common values.

In addition, the calculation section 112b calculates an evaluation value (hereinafter, also referred to as a second evaluation value) that is based on the arrangement status of each record in a case of rearranging each record that is arranged in the first collection, into either the first collection or the second collection.

More specifically, the calculation section 112b calculates the inverse of the occurrence probability of each record for each collection in a case of rearranging a record that is arranged in the first collection into either the first collection or the second collection. In addition, in this case, the calculation section 112b calculates the common value that is based on the number of collections in which each variable value is included in each collection, and the number of the variable values that are included in any one of the collections (the number of types of variable value) for each variable value. Further, the calculation section 112b calculates the second evaluation value by adding the sum total of the calculated inverses of the occurrence probability of each record to the sum total of the calculated common values.

Additionally, for example, the calculation section 112b performs calculation of the first or second evaluation value by adding a sum (hereinafter, also referred to as a first total) of logarithm (hereinafter, also referred to as a first total) of the calculated inverse of the occurrence probability of each record to a sum (hereinafter, also referred to as a second total) of logarithm of each of the calculated common values.

Furthermore, for example, the calculation section 112b calculates an evaluation value (hereinafter, also referred to as a third evaluation value) that is based on the current arrangement status of each record. More specifically, the calculation section 112b calculates the inverse of the occurrence probability of each record for each collection, which is based on the current arrangement status. In addition, in this case, the calculation section 112b calculates the common value that is based on the number of collections in which each variable value is included in each collection, and the number of the variable values that are included in any one of the collections (the number of types of variable value) for each variable value. Further, the calculation section 112b calculates the third evaluation value (hereinafter, also simply referred to as an evaluation value) by adding the sum total of the calculated inverses of the occurrence probability of each record, and the sum total of the calculated common values.

The determination section 112c performs determination of whether or not to rearrange the first record into another collection based on the first evaluation value and the second evaluation value that the calculation section 112b calculates. More specifically, the determination section 112c calculates a subtracted value (hereinafter, also referred to as a first subtracted value) by subtracting the first evaluation value from the second evaluation value, and performs determination for rearranging the first record in a case in which a second subtracted value, which is calculated by subtracting the first subtracted value from the first evaluation value, is smaller than the third evaluation value.

Additionally, the determination section 112c may be a section that calculates the second subtracted value by subtracting a value obtained by multiplying a weighting coefficient by the value of the first subtracted value, from the first evaluation value. For example, the weighting coefficient includes a number of records that belong to a collection to which the first record belongs in the initial collections.

The rearrangement section 112d rearranges the first record into another collection (a collection other than the first collection to which the first record belongs) based on the determination result of the determination section 112c. More specifically, the rearrangement section 112d rearranges the first record into a collection for which a reduction quantity with respect to the third evaluation value of an evaluation value (hereinafter, also referred to as a fourth evaluation value) that is based on the arrangement status in a case in which the first record is rearranged, is greatest.

The output section 113 outputs the generated collections after the execution of the rearrangement section 112d to an output terminal (not illustrated in the drawings).

<Flowchart of Classification of Discrete Data in Present Embodiment>

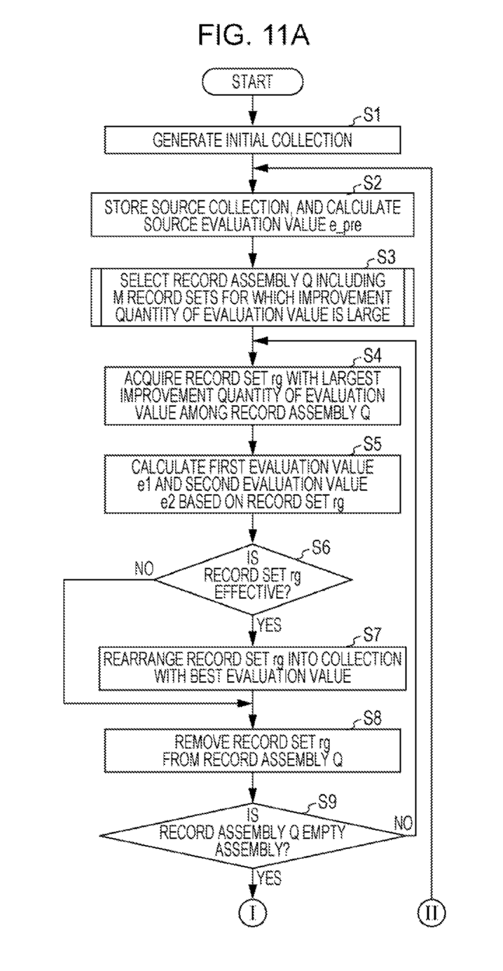

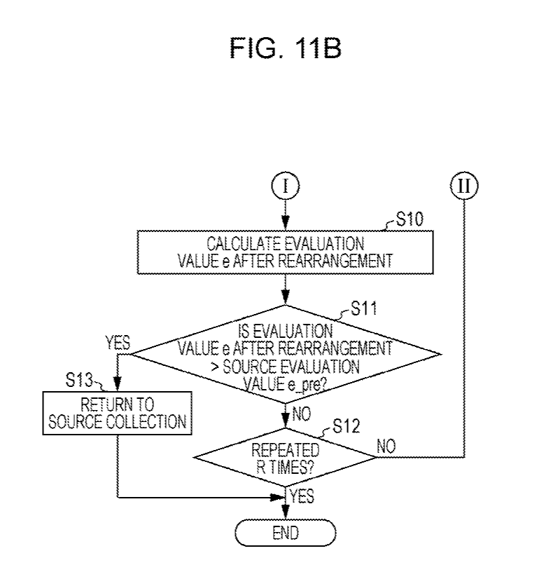

FIGS. 11A and 11B are flowcharts that describe a flow of a classification process of discrete data in the present embodiment. The input section 111 acquires discrete data prior to S1 in FIG. 11A, and inputs the discrete data to the collection generation section 112a.

Step S1: The collection generation section 112a generates initial collections by classifying a plurality of records that are included in the discrete data, which is a target of the classification process. Since S1 is the same as S111 of FIG. 3, detailed description thereof is omitted.

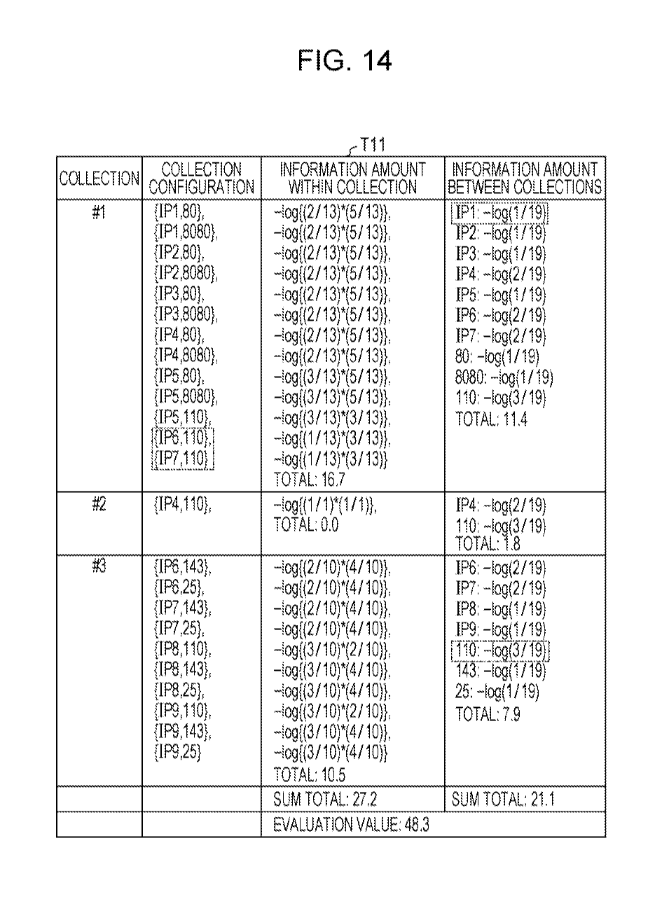

Step S2: The collection generation section 112a or the rearrangement section 112d stores the source collections in the RAM 102, calculates the third evaluation value e_pre of the source collections (hereinafter, also referred to as the source evaluation value e_pre or the evaluation value e_pre), and stores the above-mentioned value in the RAM 102. The evaluation value e_pre is the sum total of the sum of the information amounts within collection, and the sum of information amounts between collection in the source collection. The information amounts between collection will be described in detail using FIG. 14. In a case of executing S1 for the first time, the source collections are the initial collections (S1). In a case of executing S2 for a second time and onwards, the source collections are collections after S7 is finished.

In a case of executing S2 for the first time, the collection generation section 112a executes S2. In a case of executing S2 for a second time and onwards, the rearrangement section 112d executes S2, but in this case, the evaluation value that is calculated in S10 may be stored as the source evaluation value without calculating the source evaluation value e_pre. Additionally, for example, the collection generation section 112a or the rearrangement section 112d stores the collections in the form of a collection configuration table.

Step S3: The rearrangement section 112d selects a record assembly Q, which includes m records for which an improvement quantity of the evaluation value is large, where m is an integer of 1 or more. The improvement quantity is a value obtained by subtracting an increased amount (includes weighting) of the sum total of a cardinality (a fluctuation number) of variable values, from a reduction quantity of the information amount within collection. The improvement quantity of the evaluation value is indicated by Formula 1.

Improvement Quantity of Evaluation Value=(Reduction in Information Amount Within Collection)−α*(Increase in Cardinality of Variable Values) (Formula 1)

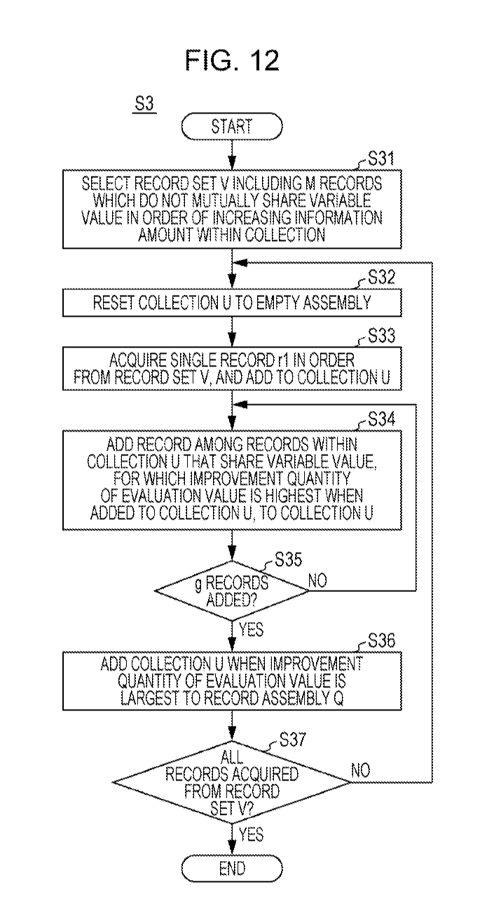

Additionally, a is a so-called weighting coefficient, and may be adjusted by an analyst as appropriate. Detailed description of S3 will be performed using the flowchart of FIG. 12.

Step S4: Among the record assembly Q, the rearrangement section 112d acquires a record set rg for which the improvement quantity of the evaluation value is largest. Additionally, the record set rg may include a single record.

Step S5: The calculation section 112b calculates a first evaluation value e1 and a second evaluation value e2, which are calculated based on the record set rg.

Step S6: The determination section 112c determines the effectiveness of the record set rg based on the first evaluation value e1 and the second evaluation value e2, which are calculated based on the record set rg by the calculation section 112b. In a case in which it is determined that the record set rg is effective (YES in S6), the process moves to S7. In a case in which it is determined that the record set rg is not effective (NO in S6), the process moves to S8 without the process of S7 being performed.

Step S7: The rearrangement section 112d rearranges the record set rg into a collection in which the evaluation value becomes the most favorable.

Step S8: The rearrangement section 112d removes the record set rg from the record assembly Q.

Step S9: The rearrangement section 112d determines whether or not the record assembly Q is an empty assembly. In a case in which the record assembly Q is not an empty assembly (NO in S9), the process moves to S4. In a case in which the record assembly Q is an empty assembly (YES in S9), the process moves to S10. Additionally, since S9 to S11 are the same as S117 to S119 of FIG. 3, detailed description thereof is omitted.

Step S10: The rearrangement section 112d calculates an evaluation value e after rearrangement.

Step S11: The rearrangement section 112d determines whether or not the evaluation value e after rearrangement exceeds the source evaluation value e_pre. In a case in which the evaluation value e after rearrangement does not exceed the source evaluation value e_pre (NO in S11), the process moves to S12. In a case in which the evaluation value e after rearrangement exceeds the source evaluation value e_pre (YES in S11), the process moves to S13.

Step S12: The rearrangement section 112d determines whether or not the steps of S2 to S11 have been repeated R times. In a case in which the rearrangement section 112d has repeated the steps of S2 to S11 R times (YES in S12), the process is finished. The rearrangement section 112d sets the collections after rearrangement at the time that the process is finished as discrete data collections after classification. Further, the rearrangement section 112d inputs the collections after rearrangement to the output section 113. The output section 113 outputs the collections after rearrangement that are input from the rearrangement section 112d to an output device, for example. In a case in which the rearrangement section 112d has not repeated the steps of S2 to S11 R times (NO in S12), the process moves to S2.

Step S13: The rearrangement section 112d returns the record set rg that was rearranged in S7 to the source collection thereof, and sets the collections before rearrangement as discrete data collections after classification. That is, in this case, the rearrangement section 112d does not perform rearrangement of the records that belong to the source collections. Further, the rearrangement section 112d inputs the collections before rearrangement to the output section 113. The output section 113 outputs the collections before rearrangement that are input from the rearrangement section 112d to an output device, for example.

FIG. 12 is a flowchart that describes a flow of a process of Step S3 in FIG. 11A.

Step S31: The rearrangement section 112d selects a record set V including m records, which do not mutually share a variable value in the order of increasing information amount within collection from among records that are included in the most recent collection configuration table.

Step S32: The rearrangement section 112d resets a collection U to an empty assembly.

Step S33: The rearrangement section 112d acquires single records r1 in order from record set V, and adds the records r1 to the collection U.

Step S34: The rearrangement section 112d selects a record, among records that share any one of the variable values within the collection U, for which the improvement quantity of the evaluation value is highest when added to the collection U from the records that are included in the most recent collection configuration table, and adds the record to the collection U.

Step S35: The rearrangement section 112d determines whether or not g records have been added, where g is an integer of 1 or more. In a case in which g records have not been added (NO in S35), the process moves to S34. In a case in which g records have been added (YES in S35), the process moves to S36.

Step S36: The rearrangement section 112d adds, to the record assembly Q, the collection U for which the improvement quantity of the evaluation value is greatest.

Step S37: The rearrangement section 112d determines whether or not all of the records have been acquired from the record set V. In a case in which all of the records have not been acquired from the record set V (NO in S37), the process moves to S32. In a case in which all of the records have been acquired from the record set V (YES in S37), S3 is finished, and the process moves to S4 of FIG. 11A.

### Specific Example

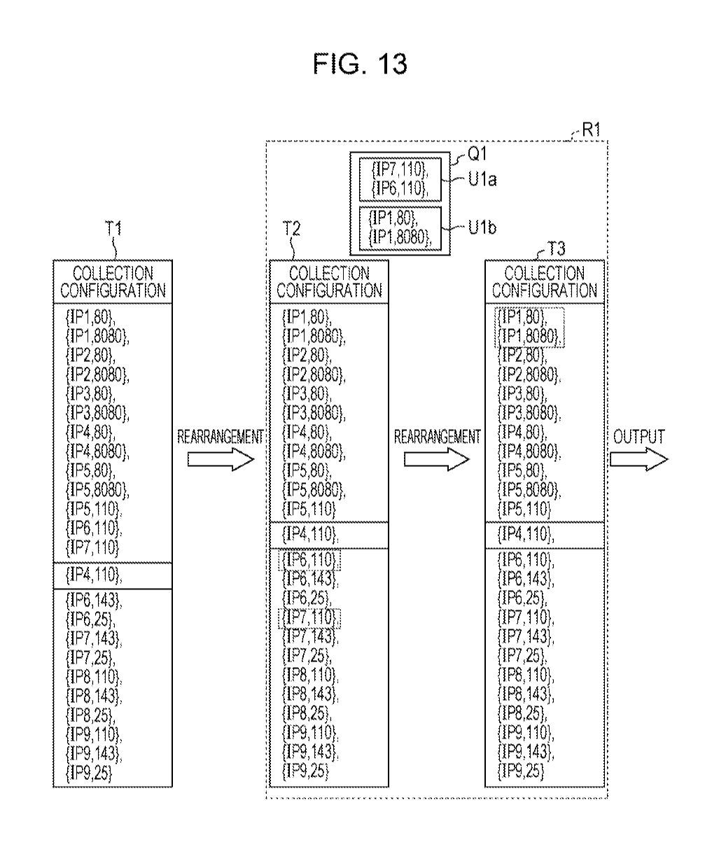

Next, a specific example of the classification of discrete data in the present embodiment will be described with reference to FIGS. 13 to 26. FIGS. 13 to 26 are first to fourteenth diagrams that describe a specific example in the present embodiment.

An outline of the specific example will be described with reference to FIG. 13. In the outline of the specific example illustrated in FIG. 13, a state is schematically illustrated in which selected records are sequentially rearranged in each collection, where a collection configuration table T1 as initial collections is set as a starting point. Additionally, cases in which records that belong to a certain collection are arranged in the same collection (that is, cases in which records are not moved) are not included in the rearrangement.

As a result of the rearrangement, the collection configuration table T1 changes to collection configuration tables T2 and T3. In the collection configuration tables T1, T2 and T3, records that belong to each collection are stored in the cells of the second row onwards. In the collection configuration tables T1, T2 and T3, records that belong to a first collection #1 are stored in the cells of the second row, which is the row after the first row in which the term “Collection Configuration” is stored. Further, records that belong to a second collection #2 are stored in the cells of the third row, and records that belong to a third collection #3 are stored in the cells of the fourth row.

The collection generation section 112a classifies a plurality of records in the manner illustrated in the collection configuration table T1 by executing a generation process (S1) of the initial collections in FIG. 11A on the discrete data LSD4 of FIG. 2. Thereafter, the rearrangement section 112d rearranges the records by executing the processes following S2 in FIG. 11A.

In FIG. 13, the records that are surrounded by the dotted line border are the record set rg that is described in S4 to S7 of FIG. 11A. In addition, the collection configuration tables T2 and T3 that are surrounded by the broken line border, which is indicated by the reference numeral R1, indicate collection configuration tables that are generated as a result of the rearrangement (refer to S7) of record collections U1a and U1b, which belong to a record assembly Q1 (refer to S3), being executed by the rearrangement section 112d. Additionally, detailed descriptions of the collection configuration tables T1, T2 and T3 will be given later.

<Initial Collections>

The initial collections will be described with reference to FIG. 14. A collection configuration table T11 of FIG. 14 is a table in which the variable value column of the collection configuration tables (T104 and T105) that are illustrated in FIGS. 7 and 8 has been switched with an information amounts between collection column. The information amounts between collection column stores information amounts between collection in a form of “variable value: information amount between collection of variable value”. The variable value is a variable value of a record that belongs to a collection that is identified by a collection identifier, which is stored in a cell, in which a row to which a cell in which the information amounts between collection are stored, belongs, and the collection column intersect.

The collection generation section 112a generates the initial collections that were described using FIG. 14 (S1). Further, as illustrated in FIG. 14, the collection generation section 112a calculates the information amounts within collection and the information amounts between collection of all of the records (S2). Furthermore, the collection generation section 112a calculates the source evaluation value e_pre (48.3) by adding the sum total (27.2) of the information amounts within collection, and the sum total (21.1) of the information amounts between collection (S2). Hereinafter, S1 and S2 will be described. Additionally, since the initial collections were described using S111 of FIG. 3, and the information amounts within collection were described using FIG. 2, description thereof will be omitted.

In the example of FIG. 14, the variable values of records that belong to the first collection #1, are the following variable values. That is, the above-mentioned variable values are IP1, IP2, IP3, IP4, IP5, IP6, IP7, 80, 8080, and 110.

The information amount between collection of a certain variable value (hereinafter, also referred to as a variable value X) is the logarithm of the inverse of the occurrence probabilities of the variable value X, which indicates the probability that the variable value X will occur in a certain collection. The occurrence probability of the variable value X is a value obtained by dividing the number of collections that include the variable value X by the total number of mutually different variable values that belong to each collection. For example, the information amounts between collection are an example of a degree of commonness of the variable values that was described using FIG. 10.

In FIG. 14, the information amounts between collection of the variable value IP1 (refer to the dotted line border) within the first collection #1 is calculated. Since only the first collection #1 includes the variable value IP1 within the first collection #1, the number of collections that include the variable value IP1 within the first collection #1 is 1.

In addition, mutually different variable values that belong to the first collection #1, are the following variable values. That is, the variable values are IP1, IP2, IP3, IP4, IP5, IP6, IP7, 80, 8080, and 110. Accordingly, the number of mutually different variable values that belong to the first collection #1, is 10. In addition, mutually different variable values that belong to the second collection #2 are IP4 and 110. Accordingly, the number of mutually different variable values that belong to the second collection #2, is 2. In addition, mutually different variable values that belong to the third collection #3 are IP6, IP7, IP8, IP9, 110, 143 and 25. Accordingly, the number of mutually different variable values that belong to the third collection #3, is 7. As a result of this, the total of the numbers of mutually different variable values that belong to each collection, is 19 (10+2+7).

Accordingly, the occurrence probability that the variable value IP1 that is included in the first collection #1 will occur in the first collection #1 is (1/19). Further, the information amount between collection of the variable value IP1 that is included in the first collection #1 is −log (1/19) (refer to the dotted line border).

The information amount between collection of the variable value 110 (refer to the dashed-dotted line border) that is included in the third collection #3 will be calculated. Since the first collection #1, the second collection #2 and the third collection #3 include the variable value 110 within the third collection #3, the number of collections that include the variable value 110 within the first collection #1 is 3. Further, in the manner mentioned above, the total of the numbers of mutually different variable values that belong to each collection, is 19 (10+2+7).

Accordingly, the occurrence probability that the variable value 110 included in first collection #1 will occur in the first collection #1 is 3/19. Further, accordingly, the information amount between collection of the variable value 110 included in the first collection #1 is −log (3/19) (refer to the dashed-dotted line border).

The total of the information amounts between collection of variable values of records that belong to a kth (lower case k is an integer of 1 or more) collection #k is indicated at the bottom of a cell in which the information amounts between collection are stored. For example, the total of the information amounts between collection of the variable values of records that belong to the first collection #1 is “11.4”. More specifically, the sum total is (−log (1/19))+(−log (1/19))+(−log (1/19))+(−log (2/19))+(−log (1/19))+(−log (2/19))+(−log (2/19))+(−log (1/19))+(−log (1/19))+(−log (3/19)).

In the collection configuration table T11, a cell in which the second row from the bottom and the information amounts between collection column intersect, stores a sum total of the information amounts between collection of each variable value in all of the collections. For example, the totals of the information amounts within collection of each variable value in the first collection #1 to the third collection #3 are respectively “11.4”, “1.8” and “7.9”. Accordingly, the above-mentioned sum total is “21.1” (11.4+1.8+7.9).

Thereafter, in a case in which a record from among records that belong to k collections is arranged into a different collection, the rearrangement section 112d selects one or more records for which a reduction quantity of the sum total of the first total and the second total is greatest. The rearrangement section 112d arranges one or more selected records into a collection (for example, the second collection) for which the reduction quantity of the sum total of the first total and the second total is greatest from a collection (for example, the first collection) to which the one or more selected records belong.

<Selection of Rearrangement Target Record Collection>

Next, the selection of the record assembly Q (S3) will be described with reference to FIGS. 14 to 16. The rearrangement section 112d selects a record set V including m records, which do not mutually share a variable value in the order of increasing information amount within collection from among records that are included in the most recent collection configuration table (including the source collections). The most recent collection configuration table is the collection configuration table T11 of FIG. 14. The rearrangement section 112d selects a record set V including the m records {IP7,110} and {IP1,80}, which do not mutually share a variable value in the order of increasing information amount within collection from among records that are included in the collection configuration table T11 of FIG. 14 (S31). In this step, m is 2.

In this instance, in the collection configuration table T11 of FIG. 14, the maximum information amount within collection is 1.8 (−log {(1/13)*(3/13)}). Additionally, in the calculation of the logarithms, numbers are rounded off to one decimal place.

The records that have the maximum information amount within collection (1.8) are the two records {IP7,110} and {IP6,110} that belong to the first collection #1 (refer to the dashed-two dotted line in FIG. 14). The variable value 110 is common to the records {IP7,110} and {IP6,110}. Accordingly, the rearrangement section 112d selects one record, for example, the record {IP7,110}, from the records {IP7,110} and {IP6,110}.

A record, which belongs to the first collection #1, does not share a variable value with the selected record {IP7,110}, and for which the information amount within collection of the record is the next largest information amount within collection after the maximum information amount within collection (1.8), is for example, the record {IP1,80}. The next largest information amount within collection after the maximum information amount within collection (1.8) is 1.2 (−log {(2/13)*(5/13)}). Accordingly, rearrangement section 112d selects the record {IP1,80}.

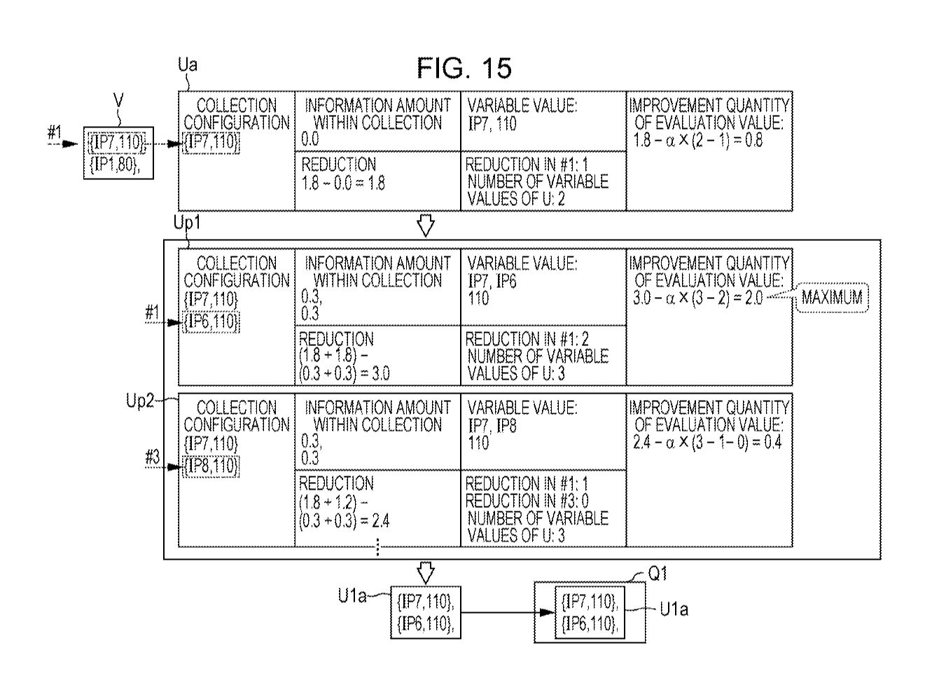

Using the above-mentioned selection process, the rearrangement section 112d selects two records {IP7,110} and {IP1,80} (S31). The rearrangement section 112d resets a collection U to an empty assembly (S32). Hereinafter, the collection U after reset will be denoted as a collection Ua. The creation of the collection Ua will be described with reference to FIG. 15.

The rearrangement section 112d acquires a single record r1 (for example, {IP7,110}) in order from the record set V that includes the two records {IP7,110} and {IP1,80}, and adds the record to the collection Ua (S33). In FIG. 15, the record {IP7,110} is indicated using a dashed-dotted line border, and the addition is indicated with a dashed-dotted line arrow. Additionally, the record {IP7,110} is a record that belongs to the first collection #1 in the collection configuration table T11 of FIG. 14 (refer to the dotted line arrow that is indicated using “#1” in the record set V of FIG. 15).

A state in which the record {IP7,110} has been added to the collection Ua is indicated by “Collection Configuration: {IP7,110}” in a cell of the collection Ua. The rearrangement section 112d calculates the information amount within collection 0.0 of the record {IP7,110} in the collection Ua. Additionally, the information amount within collection of the record {IP7,110} in the collection Ua is 0.0 (−log {(1/1)*(1/1)}).

This calculation is indicated by “Information Amount Within Collection: 0.0” in a cell of the collection Ua. The variable values of the record {IP7,110} that belongs to the collection Ua are IP7 and 110. These variable values are indicated by “Variable Values: IP7, 110” in a cell of the collection Ua.

In a case in which a record that belongs to the collection X is rearranged into another collection (hereinafter, also referred to as a collection Y), it is preferable that the sum total of the information amounts within collection is reduced as much as possible. In such an instance, it is considered how much the information amount within collection is reduced by rearranging a record that belongs to the collection X into the collection Y.

For example, as a result of rearranging the record {IP7,110} that belongs to the first collection #1 into the collection Ua, the information amount within collection (1.8) of the record {IP7,110} in the first collection #1 is reduced, and the information amount within collection of the collection Ua increases by 0.0. Additionally, the meaning of information amount within collection increasing by 0.0 is the same as that of the information amount within collection not increasing.

Accordingly, as a result of rearranging the record {IP7,110} into the collection Ua, the total information amount within collection in the first collection #1 to the third collection #3, which are indicated in the collection configuration table T11 of FIG. 14, and the collection Ua of FIG. 15, is reduced by 1.8 (1.8−0.0). This reduction is indicated by “Reduction: 1.8−0.0=1.8” in a cell of the collection Ua.

In a case in which a record that belongs to the collection X is rearranged into another collection (the collection Y), it is preferable that the shared count of the variable values is reduced. In such an instance, it is considered how much the variable values are reduced by rearranging a record that belongs to the collection X into the collection Y. In the reduction of the variable values, when variable values that are the same as the n (n is an integer of 1 or more) variable values that are included in a record are no longer included in the variable values in the collection X as a result of the record being rearranged into the collection Y, the n variable values are reduced by n.

When the record {IP7,110} that belongs to the first collection #1 in FIG. 14 is rearranged into the collection Ua, an identical variable value to the variable value IP7 is no longer included in the variable values in the first collection #1. However, even when this rearrangement is performed, the variable 110 is included in the variable values in the first collection #1. Accordingly, when the record {IP7,110} that belongs to the first collection #1 is rearranged into the collection Ua, the variable values are reduced by 1. This reduction is indicated by “Reduction in #1: 1” in a cell of the collection Ua.

In this instance, there are two variable values of the collection Ua to which the record {IP7,110} belongs. This number of variable values is indicated by “Number of Variable Values of U: 2” in a cell of the collection Ua.

In such an instance, an improvement quantity of the evaluation value in a case in which a record that belongs to the collection X is rearranged into the collection Y, is considered. As a result of this rearrangement, it is preferable that improvement quantity of the evaluation value that is indicated using (Formula 1) is large.

The improvement quantity is indicated by (Reduction in Information Amount Within Collection)−α*(Increase in Cardinality of Variable Values). In this instance, the increase in the sum total of the cardinality of variable values is set as a value obtained by subtracting the above-mentioned reduction in the variable values from the variable values of the collection U.

The improvement quantity of the evaluation value in a case in which the record {IP7,110} that belongs to the first collection #1 is rearranged into the collection Ua, is 0.8 (1.8−α*(2−1), when α is 1). This “1.8” is the reduction value of the information amount within collection. The “2” of the “2−1” is the number of variable values of the collection Ua to which the record {IP7,110} belongs, and the “1” is a reduction in the variable values. The numerical value of α may be adjusted. In the calculation of the evaluation value, which will be described later, an analyst changes the effect that the information amounts between collections has on the evaluation value by adjusting the numerical value of α. When the numerical value of a is adjusted, the contents of the records that configure each collection change. A change in the contents of the records is seen when an analyst adjusts the numerical value of α, and executes the classification of discrete data in the data classification apparatus 1. Further, classification results of discrete data according to the intentions of the analyst are obtained by executing the classification process of discrete data in the data classification apparatus 1 according to the intentions of the analyst while observing the above-mentioned change.

The rearrangement section 112d executes calculation of the information amount within collection and calculation of the improvement quantity of the evaluation value in the collection Ua, and stores the calculation results in the RAM 102.

Subsequently, the rearrangement section 112d adds a record, among records that share any one of the variable values within the collection Ua, for which the improvement quantity of the evaluation value is highest when added to the collection Ua, to the collection Ua (S34). For example, the record that shares any one of the variable values (IP7 or 110) within the collection Ua is set as {IP6,110}. The record is a record that belongs to the first collection #1 in the collection configuration table T11 of FIG. 14 (refer to the dotted line arrow that is indicated using “#1” in the collection Up1 of FIG. 15).

It is assumed that the record {IP6,110} that belongs to the first collection #1 is added to the collection Ua. A state in which the record {IP6,110} has been added to the collection Ua is indicated by “Collection Configuration: {IP7,110}, {IP6,110}” in a cell of the collection Up1. The rearrangement section 112d calculates the information amount within collection 0.3 of the records {IP7,110} and {IP6,110} in the collection Up1. The calculation formula thereof is −log {(1/2)*(2/2)}. Additionally, the value of −log {(1/2)*(2/2)} is 0.3.

This calculation is indicated by “Information Amount Within Collection: 0.3, 0.3” in a cell of the collection Up1. The variable values of the records {IP7,110} and {IP6,110} that belong to the collection Up1 are IP7, IP6 and 110. These variable values are indicated by “Variable Values: IP7, IP6, 110” in a cell of the collection Up1.

As a result of rearranging the records {IP7,110} and {IP6,110} that belong to the first collection #1 into the collection Up1, the information amount within collection (1.8) of the record {IP7,110} in the first collection #1, and the information amount within collection (1.8) of the record {IP6,110} in the first collection #1, are reduced. Further, the information amount within collection of the collection Up1 increases by 0.6 (=0.3+0.3) as a result of the rearrangement. Accordingly, as a result of rearranging the records {IP7,110} and {IP6,110} into the collection Up1, the total information amount within collection in the first collection #1 to the third collection #3, which are indicated in the collection configuration table T11 of FIG. 14, and the collection Up1 of FIG. 15, is reduced by_3.0 (=(1.8+1.8)−(0.3+0.3)). This reduction is indicated using “Reduction: (1.8+1.8)−(0.3+0.3)=3.0” in a cell of the collection Up1.

In FIG. 14, when the records {IP7,110} and {IP6,110} are rearranged into the collection Up1 from the first collection #1, identical variable values IP7 and IP6 to the variable values IP7 and IP6 are no longer included in the variable values in the first collection #1. However, even when this rearrangement is performed, the variable 110 is included in the variable values in the first collection #1. Accordingly, when the records {IP7,110} and {IP6,110} that belong to the first collection #1 are rearranged into the collection Up1, the variable values are reduced by 2. This reduction is indicated by “Reduction in #1: 2” in a cell of the collection Up1.

In this instance, there are three variable values of the collection Up1 to which the records {IP7,110} and {IP6,110} belong. This number of variable values is indicated by “Number of Variable Values of U: 3” in a cell of the collection Up1.

The improvement quantity of the evaluation value in a case in which the records {IP7,110} {IP6,110} that belong to the first collection #1 are rearranged into the collection Up1, is 2.0 (=3.0−α*(3−2), when a is 1).

The rearrangement section 112d executes calculation of the information amount within collection and calculation of the improvement quantity of the evaluation value in the collection Up1, and stores the calculation results in the RAM 102.

It is assumed that the record {IP8,110} that belongs to the third collection #3 is added to the collection Ua (refer to the dotted line arrow that is indicated using “#3” in the collection Up2 of FIG. 15). A state in which the record {IP8,110} has been added to the collection Ua is indicated by “Collection Configuration: {IP7,110}, {IP8,110}” in a cell of the collection Up2. The rearrangement section 112d calculates the information amount within collection 0.3 of the records {IP7,110} and {IP8,110} in the collection Up2. The calculation formula thereof is −log {(1/2)*(2/2)}. Additionally, the value of −log {(1/2)*(2/2)} is 0.3.

This calculation is indicated by “Information Amount Within Collection: 0.3, 0.3” inside a cell of the collection Up2. The variable values of the records {IP7,110} and {IP8,110} that belong to the collection Up2 are IP7, IP8 and 110. These variable values are indicated by “Variable Values: IP7, IP8, 110” in a cell of the collection Up2.

The record {IP7,110} is rearranged into the collection Up2 from the first collection #1, and the record {IP8,110} is rearranged into the collection Up2 from the third collection #3. As a result of this rearrangement, the information amount within collection (1.8) of the record {IP7,110} in the first collection #1 and the information amount within collection (1.2) of the record {IP8,110} in the third collection #3 decrease, and the information amount within collection of the collection Up2 increases by 0.6 (=0.3+0.3). Additionally, the information amount within collection of the record {IP8,110} in the third collection #3 is 1.2 (=−log {(3/10)*(2/10)}).

Accordingly, as a result of rearranging the records {IP7,110} and {IP8,110} into the collection Up2, the total information amount within collection in the first collection #1 to the third collection #3, which are indicated in the collection configuration table T11 of FIG. 14, and the collection Up2 of FIG. 15, is reduced by 2.4 (=(1.8+1.2)−(0.3+0.3)). This reduction is indicated using “Reduction: (1.8+1.2)−(0.3+0.3)=2.4” in a cell of the collection Up2.

When the record {IP7,110} that belongs to the first collection #1 is rearranged into the collection Up2, an identical variable value IP7 to the variable value IP7 is no longer included in the variable values in the first collection #1. Accordingly, when the record {IP7,110} that belongs to the first collection #1 is rearranged into the collection Up2, the variable values are reduced by 1. This reduction is indicated using “Reduction in #1: 1” in a cell of the collection Up2.

When the record {IP8,110} that belongs to the third collection #3 is rearranged into the collection Up2, identical variable values IP8 and 110 to the variable values IP8 and 110 are still included in the variable values in the third collection #3. Accordingly, when the record {IP8,110} that belongs to the third collection #3 is rearranged into the collection Up2, the variable values are not reduced. This lack of a reduction is indicated using “Reduction in #3: 0” in a cell of the collection Up2.

In this instance, there are three variable values of the collection Up2 to which the records {IP7,110} and {IP8,110} belong. This number of variable values is indicated by “Number of Variable Values of U: 3” in a cell of the collection Up2.

The improvement quantity of the evaluation value in a case in which the record {IP7,110} that belongs to the first collection #1 and the record {IP8,110} that belongs to the third collection #3 are rearranged into the collection Up2, is 0.4 (2.4−α*(3−1−0), when α is 1).

The rearrangement section 112d executes calculation of the information amount within collection and calculation of the improvement quantity of the evaluation value in the collection Up2, and stores the calculation results in the RAM 102.

In the abovementioned manner, the improvement quantity of the evaluation value is 2.0 when the record {IP6,110} is added to the collection Ua, and this improvement quantity of the evaluation value is the maximum (refer to the “maximum” balloon in FIG. 15). In such an instance, the rearrangement section 112d adds the record {IP6,110} to the collection Ua (S34).

The rearrangement section 112d determines whether or not g (for example, 1) records have been added (S35). Since a single record has already been added to the collection Ua (YES in S35), the rearrangement section 112d adds the collection Up1 for which the improvement amount of the evaluation value is greatest to the record assembly Q1 (S36). Hereinafter, a collection of two records that are included in the collection Up1 for which the improvement quantity of the evaluation value is greatest is indicated as a collection U1a.

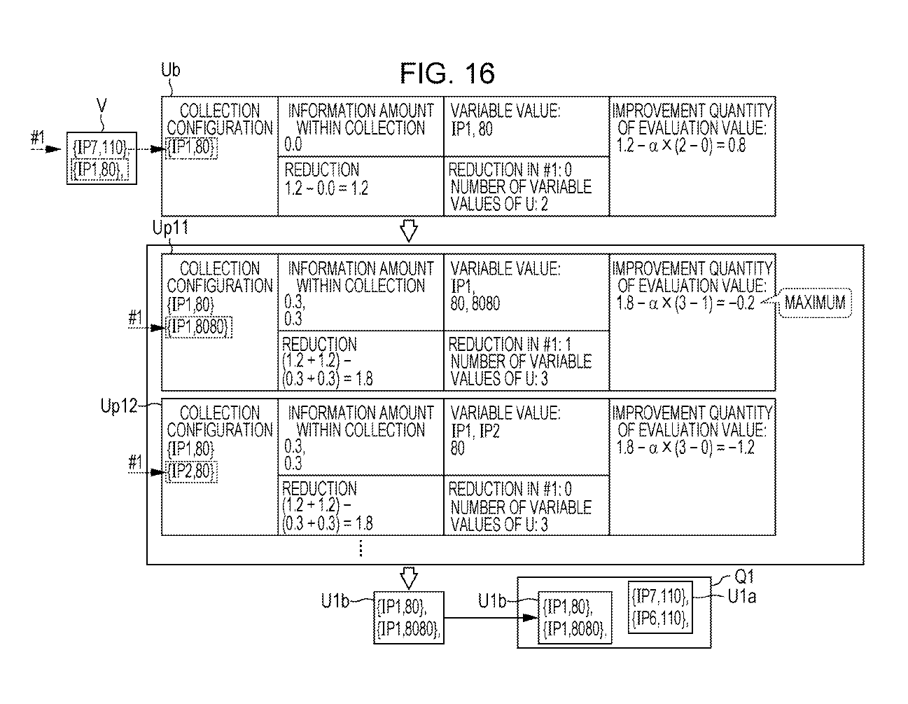

Since the rearrangement section 112d has acquired a single record r1 ({IP7,110}) in order from the record set V including the two records {IP7,110} and {IP1,80}, all records have not been acquired from the record set V (NO in S37). Accordingly, the rearrangement section 112d resets the collection U to an empty assembly (S32). Hereinafter, the collection U after reset will be denoted as a collection Ub. The creation of the collection Ub will be described with reference to FIG. 16.

The rearrangement section 112d acquires a single record r1 (for example, {IP1,80}) in order from the record set V that includes the two records {IP7,110} and {IP1,80}, and adds the record to the collection Ub(S33). In FIG. 16, the record {IP1,80} is indicated using a dashed-dotted line, and the addition is indicated with a dashed-dotted line arrow. Additionally, the record {IP1,80} is a record that belongs to the first collection #1 in the collection configuration table T11 of FIG. 14 (refer to the dotted line arrow that is indicated using “#1” in the record set V of FIG. 16) (S33).

A state in which the record {IP1,80} has been added to the collection Ub is indicated by “Collection Configuration: {IP1,80} ” in a cell of the collection Ub. The rearrangement section 112d calculates the information amount within collection 0.0 of the record {IP1,80} in the collection Ub. This calculation is indicated by “Information Amount Within Collection: 0.0” inside a cell of the collection Ub. The variable values of the record {IP1,80} that belongs to the collection Ub are IP1 and 80. These variable values are indicated by “Variable Values: IP1, 80” in a cell of the collection Ub.

For example, as a result of rearranging the record {IP1,80} that belongs to the first collection #1 into the collection Ub, the information amount within collection (1.2) of the record {IP1,80} in the first collection #1 is reduced, and the information amount within collection of the collection Ub increases by 0.0. Additionally, the information amount within collection of the record {IP1,80} in the first collection #1 is 1.2 (=−log {(2/13)*(5/13)}).

Accordingly, as a result of rearranging the record {IP1,80} into the collection Ub, the total information amount within collection in the first collection #1 to the third collection #3, which are indicated in the collection configuration table T11 of FIG. 14, and the collection Ub of FIG. 16, is reduced by 1.2 (=1.2−0.0). This reduction is indicated using “Reduction: 1.2−0.0=1.2” in a cell of the collection Ub.

Even when the record {IP1,80} that belongs to the first collection #1 is rearranged into the collection Ub, the variable values IP1 and 80 are included in the variable values in the first collection #1. Accordingly, even when the record {IP1,80} that belongs to the first collection #1 is rearranged into the collection Ub, the variable values are not reduced. This lack of a reduction is indicated using “Reduction in #1: 0” in a cell of the collection Ub.

In this instance, there are two variable values of the collection Ub to which the record {IP1,80} belongs. This number of variable values is indicated by “Number of Variable Values of U: 2” in a cell of the collection Ub.

The improvement quantity of the evaluation value in a case in which the record {IP1,80} that belongs to the first collection #1 is rearranged into the collection Ub, is −0.8 L=1.2−α*(2−0), when a is 1). This “1.2” is the reduction value of the information amount within collection. The “2” of the “(2−0)” is the number of variable values of the collection Ub to which the record {IP1,80} belongs, and the “0” is a reduction in the variable values.

The rearrangement section 112d executes calculation of the information amount within collection and calculation of the improvement quantity of the evaluation value in the collection Ub, and stores the calculation results in the RAM 102.

Subsequently, the rearrangement section 112d adds a record, among records that share any one of the variable values within the collection Ub, for which the improvement amount of the evaluation value is highest when added to the collection Ub, to the collection Ub (S34). For example, the record that shares any one of the variable values within the collection Ub (IP1 and 80) is set as {IP1,8080}. The record is a record that belongs to the first collection #1 in the collection configuration table T11 of FIG. 14.

It is assumed that the record {IP1,8080} is added to the collection Ub (refer to the dotted line arrow that is indicated using “#1” in the collection Up11 of FIG. 16). A state in which the record {IP1,8080} has been added to the collection Ub is indicated by “Collection Configuration: {IP1,80}, {IP1,8080}” in a cell of the collection Up11. The rearrangement section 112d calculates the information amount within collection 0.3 in the collection Up1 of the records {IP1,80} and {IP1,8080} in the collection Up11. The calculation formula thereof is −log {(1/2)*(2/2)}. Additionally, the value of −log {(1/2)*(2/2)} is 0.3.

This calculation is indicated by “Information Amount Within Collection: 0.3, 0.3” inside a cell of the collection Up11. The variable values of the records {IP1,80} and {IP1,8080} that belong to the collection Up11 are IP1, 80 and 8080. These variable values are indicated by “Variable Values: IP1, 80, 8080” in a cell of the collection Up11.

As a result of rearranging the records {IP1,80} and {IP1,8080} that belong to the first collection #1 into the collection Up11, the information amount within collection (1.2) of the record {IP1,80} in the first collection #1, and the information amount within collection (1.2) of the record {IP1,8080} in the first collection #1, are reduced. Further, the information amount within collection of the collection Up11 increases by 0.6 (=0.3+0.3).

Accordingly, as a result of rearranging the records {IP1,80} and {IP1,8080} into the collection Up11, the total information amount within collection in the first collection #1 to the third collection #3, which are indicated in the collection configuration table T11 of FIG. 14, and the collection Up11 of FIG. 16, is reduced by 1.8 (=(1.2+1.2)−(0.3+0.3)). This reduction is indicated using “Reduction: (1.2+1.2)−(0.3+0.3)=1.8” in a cell of the collection Up11.

When the records {IP1,80} and {IP1,8080} that belong to the first collection #1 in FIG. 14, are rearranged into the collection Up11, an identical variable value IP1 to the variable value IP1 is no longer included in the variable values in the first collection #1. However, even when this rearrangement is performed, the variables 80 and 8080 are included in the variable values in the first collection #1. Accordingly, when the records {IP1,80} and {IP1,8080} that belong to first collection #1 are rearranged into the collection Up11, the variable values are reduced by 1. This reduction is indicated using “Reduction in #1: 1” in a cell of the collection Up11.

In this instance, there are three variable values of the collection Up11 to which the records {IP1,80} and {IP1,8080} belong. This number of variable values is indicated by “Number of Variable Values of U: 3” in a cell of the collection Up11.

The improvement quantity of the evaluation value in a case in which the records {IP1,80} and {IP1,8080} that belong to the first collection #1 are rearranged into the collection Up11, is −0.2 (=1.8−α*(3−1), when a is 1).

The rearrangement section 112d executes calculation of the information amount within collection and calculation of the improvement quantity of the evaluation value in the collection Up11, and stores the calculation results in the RAM 102.

It is assumed that the record {IP2,80} that belongs to the first collection #1 is added to the collection Ub (refer to the dotted line arrow that is indicated using “#1” in the collection Up12 of FIG. 16). A state in which the record {IP2,80} has been added to the collection Ub is indicated by “Collection Configuration: {IP1,80}, {IP2,80}” in a cell of the collection Up12. The rearrangement section 112d calculates the information amount within collection 0.3 of the records {IP1,80} and {IP2,80} in the collection Up12. The calculation formula thereof is −log {(1/2)*(2/2)}. Additionally, the value of −log {(1/2)*(2/2)} is 0.3.

This calculation is indicated by “Information Amount Within Collection: 0.3, 0.3” inside a cell of the collection Up12. The variable values of the records {IP1,80} and {IP2,80} that belong to the collection Up12 are IP1, IP2 and 80. These variable values are indicated by “Variable Values: IP1, IP2, 80” in a cell of the collection Up12.

As a result of rearranging the records {IP1,80} and {IP2,80} that belong to the first collection #1 into the collection Up12, the information amount within collection (1.2) of the record {IP1,80} in the first collection #1, and the information amount within collection (1.2) of the record {IP2,80} in the first collection #1, are reduced. Further, the information amount within collection of the collection Up12 increases by 0.6 (=0.3+0.3). Additionally, the information amount within collection of the record {IP2,80} in the first collection #1 is 1.2 (=−log {(2/13)*(5/13)}).

Accordingly, as a result of rearranging the records {IP1,80} and {IP2,80} into the collection Up12, the total information amount within collection in the first collection #1 to the third collection #3, which are indicated in the collection configuration table T11 of FIG. 14, and the collection Up12 of FIG. 16, is reduced by 1.8 (=(1.2+1.2)−(0.3+0.3)). This reduction is indicated using “Reduction: (1.2+1.2)−(0.3+0.3)=1.8” in a cell of the collection Up12.

Even when the records {IP1,80} and {IP2,80} that belong to the first collection #1 are rearranged into the collection Up12, identical variable values IP1, IP2 and 80 to the variable values IP1, IP2 and 80 are still included in the variable values in the first collection #1. Accordingly, even when the records {IP1,80} and {IP2,80} that belong to the first collection #1 are rearranged into the collection Up12, the variable values are not reduced. This lack of a reduction is indicated using “Reduction in #1: 0” in a cell of the collection Up12.

In this instance, there are three variable values of the collection Up12 to which the records {IP1,80} and {IP2,80} belong. This number of variable values is indicated by “Number of Variable Values of U: 3” in a cell of the collection Up12.

The improvement quantity of the evaluation value in a case in which the records {IP1,80} and {IP2,80} that belong to the first collection #1 are rearranged into the collection Up12, is −1.2 (=1.8−α*(3−0), when a is 1).

The rearrangement section 112d executes calculation of the information amount within collection and calculation of the improvement quantity of the evaluation value in the collection Up12, and stores the calculation results in the RAM 102.

In the abovementioned manner, the improvement quantity of the evaluation value of a case in which the record {IP1,8080} is added to the collection Ub, is −0.2, and this improvement quantity of the evaluation value is the maximum (refer to the “maximum” balloon in FIG. 16). In such an instance, the rearrangement section 112d adds the record {IP1,8080} to the collection Ub (S34).

The rearrangement section 112d determines whether or not g (for example, 1) records have been added (S35). Since a single record has already been added to the collection Ua (YES in S35), the rearrangement section 112d adds the collection Up11 for which the improvement amount of the evaluation value is greatest to the record assembly Q1 (S36). Hereinafter, a collection of two records that are included in the collection Up11 for which the improvement quantity of the evaluation value is greatest is indicated as a collection U1b.

As described in FIGS. 12, 15 and 16, in the selection of one or more records to be rearranged, the rearrangement section 112d selects records that do not mutually share a variable value in an order in which the logarithm of the inverse of the occurrence probability (for example, the information amount within collection) increases (S31). In the examples of FIGS. 15 and 16, the rearrangement section 112d selects a record set V including the records {IP7,110} and {IP1,80} (S31).

Further, the rearrangement section 112d executes a first addition process that adds a selected record A (for example, the record {IP7,110} of FIG. 15) to another collection (for example, the collection Ua of FIG. 15) other than the k collections (S33). Further, the rearrangement section 112d selects a record B (for example, the record {IP6,110} of FIG. 15) that includes a single variable value of any one of the single variable values that are included in the record A, from the records that are included in the discrete data LSD4 (S33). The rearrangement section 112d executes a second addition process that adds the selected record B to the other collection Ua (S33).

The rearrangement section 112d estimates a reduction quantity of a first total and a second total each time a record is added to the other collection. In the estimation, for example, the rearrangement section 112d calculates the improvement quantity of the evaluation value of FIG. 15. The rearrangement section 112d selects the other collection (for example, the record collection U1a of FIG. 15) of a case in which the maximum subtracted value is estimated as one or more record to be rearranged.

In the estimation of the reduction quantity, the rearrangement section 112d executes the following calculation process each time a record is added to the other collection. That is, the rearrangement section 112d calculates a first sum of the logarithms of the inverses of the occurrence probabilities (for example, information amounts within collection) of one or more records C, which belong to the other collection, in the respective k collections. Further, the rearrangement section 112d calculates a second sum of the logarithms of the inverses of the occurrence probabilities (for example, information amounts within collection) of the one or more records C in the respective other collections. Subsequently, the rearrangement section 112d calculates a first value obtained by subtracting the second sum from the first sum.

Next, the rearrangement section 112d calculates a second value obtained by subtracting a number of the variable values in a case in which the variable values that are included in the record C are no longer included in the corresponding collection when the respective records C are removed from the collection to which the records C belong, from the sum total of mutually different variable values that are included in the other collection.

The rearrangement section 112d calculates a subtracted value obtained by subtracting the second value from the first value, and sets the subtracted value as an estimation of the reduction quantity. This estimation of the reduction quantity is the improvement quantity of the evaluation value. In the calculation of the subtracted value, the rearrangement section 112d sets a value obtained by subtracting a value obtained by multiplying the weighting coefficient by the second value, from the first value as the subtracted value. For example, the weighting coefficient is α (for example, 1) that was described in FIGS. 15 and 16, and may be adjusted.

In this instance, in the example of FIG. 15, a case in which the record {IP7,110} is added to the collection U (refer to the collection Ua), is set as a first case. Further, in the example of FIG. 15, a case in which the record {IP6,110} is added to the collection Ua (refer to the collection Up1), is set as a second case.

In the first case, as illustrated in FIGS. 14 and 15, the first sum is the information amount within collection (1.8), the second sum is the information amount within collection (0.0), and the first value is “Reduction: 1.8−0.0=1.8”. In the first case, the record C is the record {IP7,110} that belongs to the first collection #1 in FIG. 14. In the first case, the mutually different variable values that are included in the other collection Ua are IP7 and 110, and the sum total of the variable values is 2 (“Number of Variable value of U: 2”). In the first case, the number of variable values is 1 in a case in which the variable values that are included in the record C are no longer included in the first collection #1, as indicated by “Reduction in #1: 1” in FIG. 15. Accordingly, in the first case, the second value is 1 (=2−1). In the first case, the subtracted value (that is, the improvement quantity in the evaluation value) obtained by subtracting the second value from the first value is “1.8−α(2−1)=0.8” (for example, α is 1).

In the second case, as illustrated in FIGS. 14 and 15, the first sum is the information amounts within collection (1.8+1.8), the second sum is the information amounts within collection (0.3+0.3), and the first value is “Reduction: (1.8+1.8)−(0.3+0.3)=3.0”. In the second case, the records C are the records {IP7,110} and {IP6,110} that belong to the first collection #1 in FIG. 14. In the second case, the mutually different variable values that are included in the other collection Up1 are IP7, IP6 and 110, and the sum total of the variable values is 3 (“Number of Variable value of U: 3”).

As illustrated in FIG. 15, in the second case, the number of variable values in a case in which the variable values that are included in the records C are no longer included in the first collection #1, is 2, indicated by “Reduction in #1: 2”. Accordingly, in the second case, the second value is 1 (=3−2). In the second case, the subtracted value (that is, the improvement quantity in the evaluation value) obtained by subtracting the second value (1.0) from the first value (3.0) is “3.0−a (3−2)=2.0” (for example, a is 1).

In the first addition process, the rearrangement section 112d selects m (an integer of 1 or more) records that do not mutually share a variable value (S31). Additionally, m may be denoted as Nb. Further, the rearrangement section 112d adds a single record to the other collection in the order in which the logarithms of the inverses of the occurrence probabilities (for example, information amounts within collection) increase (S32). The first addition process will be explained using the above-mentioned first case.

Subsequently, in the second addition process, the rearrangement section 112d creates a collection for rearrangement (for example, the record collection U1a of FIG. 15) for which the improvement quantity of the evaluation value is greatest by adding g (an integer of 1 or more) records B to the other collection (S34). When the addition of g records B has been finished (YES in S35), the rearrangement section 112d stores the other collection in a storage section (for example, the RAM 102) as a collection for rearrangement (S36). Further, the rearrangement section 112d repeatedly performs the first and second addition processes until all of the Nb records, which do not mutually share a variable value have been added to the other collection (S33 to S36). That is, the rearrangement section 112d repeatedly performs the first and second addition processes, and when all of the Nb records that do not mutually share a variable value have been added to the other collection, selects a rearrangement collection that is stored in the RAM 102 as the one or more records (that is, the records that correspond to rearrangement targets).

Hereinafter, the rearrangement section 112d rearranges the one or more selected records (that is, the records that correspond to rearrangement targets) into a collection for which the reduction quantity of the sum total of the total of the information amounts within collection and the total of the information amounts between collection is greatest. Additionally, the collection is any one of the first collection #1 to the third collection #3.

Acquisition of Record Set to be Rearranged

Since the rearrangement section 112d has acquired all of the records ({IP7,110} and {IP1,80}) from the record set V (YES in S37), the process moves to S4. Among the record assembly Q1, the rearrangement section 112d acquires a record set rg for which the improvement quantity of the evaluation value is largest (S4).

In the example of FIG. 15, the largest improvement quantity of the evaluation value is 2.0, and the records that belong to the collection Up1 (the collection U1a) when the improvement quantity of the evaluation value is largest are the records {IP7,110} and {IP6,110}. Further, in the example of FIG. 16, the largest improvement quantity of the evaluation value is −0.2, and the records that belong to the collection Up11 (the collection U1b) when the improvement quantity of the evaluation value is largest are the records {IP1,80} and {IP1,8080}.

Accordingly, in the example of FIG. 15, in the record assembly Q1 the record set rg for which the improvement quantity of the evaluation value is largest, is the records that belong to the collection Up1 (the collection U1a) when the largest improvement quantity of the evaluation value (2.0) is attained. Accordingly, the rearrangement section 112d acquires the record set rg (the collection U1a) (S4).

<Determination of Record Set to be Rearranged>

The calculation section 112b calculates a first evaluation value e1 and a second evaluation value e2 based on the record set rg (the collection U1a) that was acquired in S4 (S5). Further, the determination section 112c determines the effectiveness of the record set rg that was acquired in S4 (S6).

More specifically, the determination section 112c determines whether or not the record set rg that was acquired in S4 is a record set rg that may improve the evaluation value as a result of performing rearrangement (S6). In this instance, even when it is not possible to improve the evaluation value as a result of performing rearrangement of the record set rg, the record set rg that may improve the evaluation value may improve the evaluation value on a long term basis by continuing to perform rearrangement of other record sets that are included in the record assembly Q1. Further, in a case in which it is determined that the evaluation value is impossible to be improved in the record set rg that was acquired in S4 on a long-term basis, the determination section 112c performs determination to not perform the process of S7 for the record set rg that was acquired in S4 (NO in S6).

That is, depending on the case, there is a possibility that the collection configuration table that was described using FIG. 14 and the like, includes an enormous number (for example, tens of thousands), and there is also a possibility that the number of variable values that are included in each record is enormous. In such a case, for example, there are cases in which there is not rearrangement destination that may improve the evaluation value as a result of the record set rg being rearranged into collections into which rearrangement is possible. Meanwhile, in a record set rg in which the evaluation value is impossible to be improved, there are cases in which it is not possible to perform improvement of the evaluation value as a result of the rearrangement of the record set rg, but there are record sets that may improve the evaluation value on a long term basis by continuing to perform rearrangement of other record sets that are included in the record assembly Q1.

In such an instance, the determination section 112c determines whether or not the record set rg that was acquired in S4 is a record set rg that may improve the evaluation value as a result of performing rearrangement thereof (S6). Further, the determination section 112c performs rearrangement for the record set rg that may improve the evaluation value as a result of performing rearrangement thereof (YES in S6, S7). That is, even in a case of a record set rg in which the evaluation value is impossible to be improved as a result of rearrangement thereof, the determination section 112c performs rearrangement for a record set rg that may improve the evaluation value as a result of continuing to perform rearrangement of another record set that is included in the record assembly Q1. Meanwhile, the determination section 112c does not perform rearrangement for the record set rg in which the evaluation value is impossible to be improved as a result of performing rearrangement thereof (NO in S6). That is, the determination section 112c does not perform rearrangement for a record set rg in which the evaluation value is impossible to be improved as a result of rearrangement thereof, or in which the evaluation value is impossible to be improved even when the rearrangement of another record set that is included in the record assembly Q1 is continually performed.

As a result of this, for example, the classification section 112 may continue the rearrangement of records even when a state in which there is not a rearrangement destination that may improve the evaluation value as a result of performing rearrangement of the records.

Additionally, hereinafter, a record set rg that may improve the evaluation value as a result of performing rearrangement thereof will be referred to as an effective record set rg. Hereinafter, specific examples of S5 and S6 will be described.

Firstly, the calculation section 112b calculates an evaluation value (the first evaluation value e1) in a case in which the record set rg being rearranged into a new collection (hereinafter, also referred to as a virtual collection #0) (S5) is assumed.

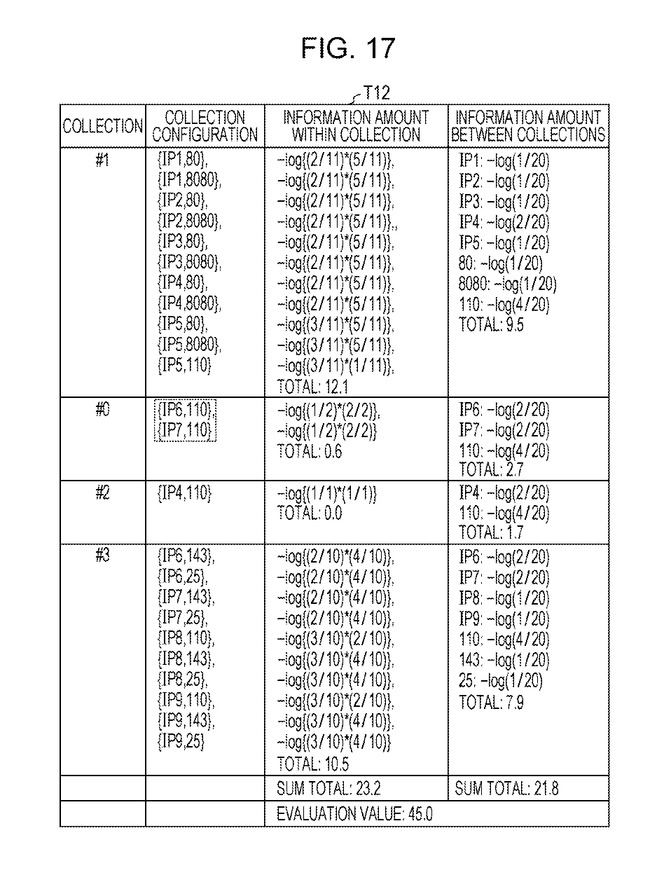

FIG. 17 is a drawing that describes the collection configuration table T12 of a case in which the record set rg is rearranged into the virtual collection #0 (refer to the dotted line border). More specifically, in the collection configuration table that is illustrated in FIG. 17, the records {IP7,110} and {IP6,110} are rearranged into the virtual collection #0 from the first collection #1. Further, the calculation section 112b refers to the collection configuration table T12 that is illustrated in FIG. 17, and calculates the first evaluation value e1 in the same manner as the case that is described in FIG. 14. More specifically, the calculation section 112b calculates 45.0 as the first evaluation value e1.

Next, the calculation section 112b assumes that the records that belong to the first collection #1 (the source collection to which the records {IP7,110} and the {IP6,110} belong) in the collection configuration table T11 that is illustrated in FIG. 14, is randomly rearranged into any one of the first collection #1 and the virtual collection #0. Further, the calculation section 112b calculates an evaluation value (the second evaluation value e2) in this case (S5).

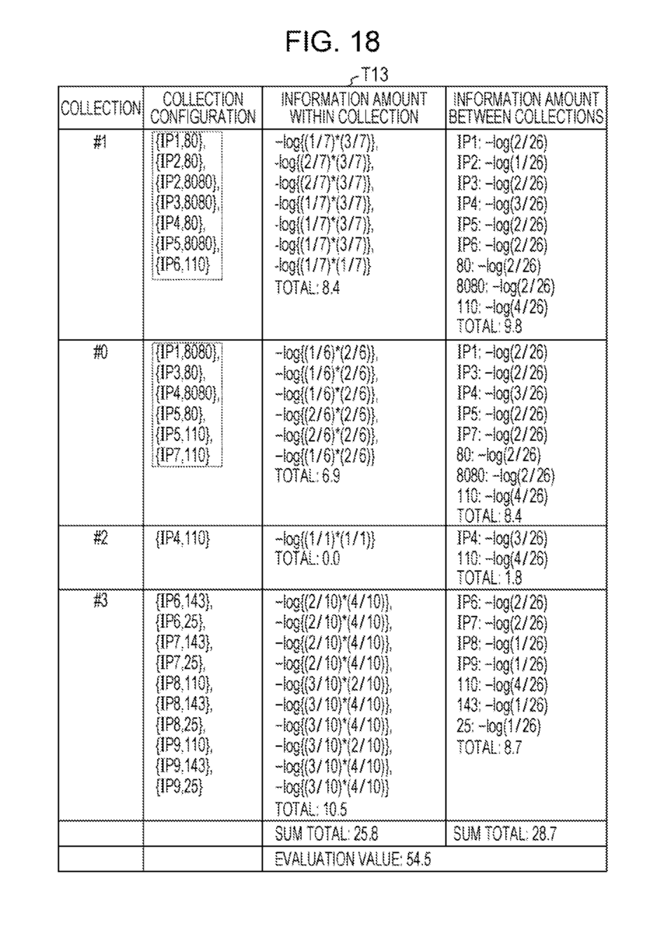

FIG. 18 is a drawing that describes the collection configuration table T13 that is illustrated in FIG. 14 when a record arranged in the first collection #1 in the collection configuration table T11 is randomly arranged into any one of the first collection #1 and the virtual collection #0 (refer to the dotted line border). More specifically, in the collection configuration table that is illustrated in FIG. 18, the records {IP1,80}, {IP2,80}, {IP2,8080}, {IP3,8080}, {IP4,80}, {IP5,8080}, and {IP6,110} are arranged into the first collection #1. In addition, in the collection configuration table that is illustrated in FIG. 18, the records {IP1,8080}, {IP3,80}, {IP4,8080}, {IP5,80}, {IP5,110}, and {IP7,110} are arranged into the virtual collection #0. Further, the calculation section 112b refers to the collection configuration table T13 that is illustrated in FIG. 18, and calculates the second evaluation value e2 in the same manner as the case that is described in FIG. 14. More specifically, the calculation section 112b calculates 54.5 as the second evaluation value e2.

Thereafter, in a case in which the following Formula 2 is established, the determination section 112c determines that the record set rg that is acquired in S4 is an effective record set rg (S6).

(First evaluation value e1)−E*(the number of records that belong to the source collection in which the record set rg have been arranged)*(second evaluation value e2−first evaluation value e1)<(source evaluation value e_pre) (Formula 2)

Additionally, ε is a so-called weighting coefficient (a coefficient that is formed from a value that is larger than 0), and may be adjusted as appropriate by an analyst.

In Formula 2, the value of the left side increases by the extent to which the first evaluation value e1 and the second evaluation value e2, which are based on a certain record set rg, are close values, or the extent to which the first evaluation value e1, which is based on a certain record set rg, is a value that is larger than the second evaluation value e2. Therefore, the first evaluation value e1 and the second evaluation value e2 act in a manner that avoids the establishment of Formula 2 by the extent to which the first evaluation value e1 and the second evaluation value e2 are close values, or the extent to which the first evaluation value e1, which is based on a certain record set rg, is a value that is larger than the second evaluation value e2. Meanwhile, in Formula 2, the value of the right side decreases by the extent to which the second evaluation value e2, which is based on a certain record set rg, is a value that is larger than the first evaluation value e1. Therefore, the first evaluation value e1 and the second evaluation value e2 act in a manner that establishes Formula 2 to the extent that the second evaluation value e2 is the value that is larger than the first evaluation value e1.

That is, it may be understood that the rearrangement of a record set rg, for which the first evaluation value e1 and the second evaluation value e2 are close values is no different from an effect that improves the evaluation value in comparison with a case in which a record set, which is selected from the first collection #1 at random, is rearranged. Furthermore, it may be understood that the rearrangement of a record set rg, for which the first evaluation value e1 is larger than the second evaluation value e2 causes the evaluation value to be worse than a case in which a record set, which is selected from the first collection #1 at random, is rearranged. Therefore, the determination section 112c may determine that it is not possible to improve the evaluation value even when rearrangement is performed for a record set rg for which Formula 2 was not established, and decide not to perform rearrangement.

In addition, in Formula 2, in a case in which the second evaluation value e2 is larger than the first evaluation value e1, the value of the left side decreases by the extent to which the number of records that belong to the source collection in which the record set rg is arranged, is large. That is, in a case in which the second evaluation value e2 is larger than the first evaluation value e1, the number of records that belong to the source collection in which the record set rg is arranged, acts in a manner that establishes Formula 2 by the extent to which the record number is large.

More specifically, in Formula 2, in a case in which ε is 0.1, the left side is 32.6, and the right side is 48.3 (refer to FIG. 14). Accordingly, in this case, the determination section 112c determines that Formula 2 has been established, and determines that the record set rg is effective (YES in S6). Meanwhile, in the above-mentioned example, for example, in a case in which the source evaluation value e_pre (the right side of Formula 2) is 30.0, the determination section 112c determines that Formula 2 has not been established, and determines that the record set rg is not effective (NO in S6).

As a result of this, for example, the data classification apparatus 1 may perform determination of whether or not rearrangement of the record set rg has to be performed even in a case in which there is not a collection that may improve the evaluation value as a result of rearrangement of the record set rg, in collections into which it is possible to rearrange the record set rg that was acquired in S4. That is, the data classification apparatus 1 may perform determination of whether or not the record set rg that was acquired in S4 is a record set rg in which the evaluation value is impossible to be improved even when rearrangement thereof is performed, but is a record set rg that may improve the evaluation value on a long-term basis by continuing rearrangement. Therefore, the data classification apparatus 1 may perform rearrangement for improving the evaluation value even in a case in which there is not a collection that may improve the evaluation value in a case in which rearrangement of the record set rg that was acquired in S4 is rearranged into a collection into which it is possible to rearrange the record set rg that was acquired in S4.

In addition, the data classification apparatus 1 may perform determination to not perform rearrangement for a record set rg in which the evaluation value is impossible to be improved as a result of rearrangement thereof, and in which the evaluation value is impossible to be improved on a long-term basis either. As a result of this, for example, the data classification apparatus 1 may perform the classification of discrete data efficiently.

<Rearrangement of Record Set>

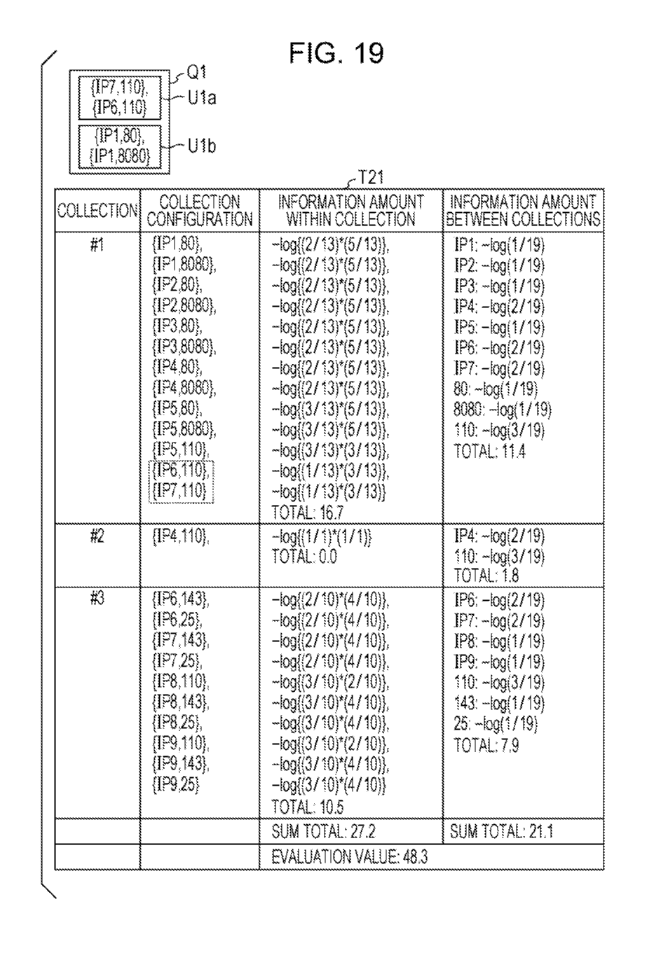

In a case in which the record set rg is effective (YES in S6), the rearrangement section 112d rearranges the record set rg into a collection for which the evaluation value is most favorable when the record set rg (the collection U1a) is rearranged into any single collection of the first collection #1 to the third collection #3 (S7). This rearrangement will be described with respect to FIGS. 19 to 21.

The rearrangement section 112d calculates each value in a case in which the record set rg (the collection U1a) is rearranged into the first collection #1 to the third collection #3. These values are the information amounts within collection and the information amounts between collection of all of the records, the total of the information amounts within collection and the total of the information amounts between collection in each collection, the sum total of the information amounts within collection and the sum total of the information amounts between collection, and the evaluation value.

FIG. 19 illustrates a collection configuration table T21 when the record set rg (the collection U1a) is not rearranged (refer to the dotted line border).

The collection configuration table T21 indicates the information amounts within collection and the information amounts between collection of all of the records, the total of the information amounts within collection and the total of the information amounts between collection in each collection, the sum total (27.2) of the information amounts within collection and the sum total (21.1) of the information amounts between collection, and the evaluation value (48.3).

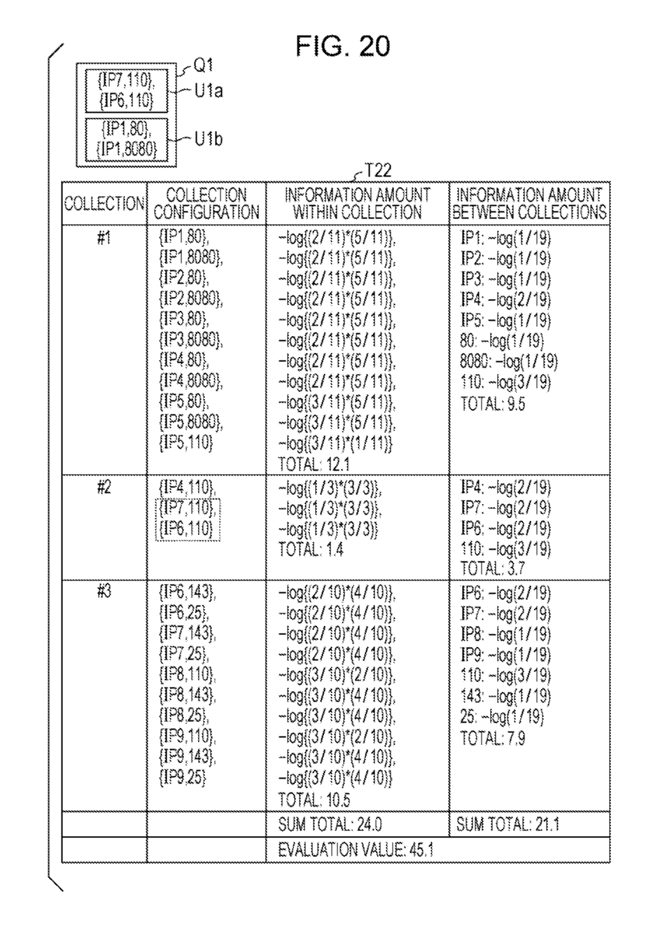

FIG. 20 illustrates a collection configuration table T22 when the record set rg (the collection U1a) is rearranged into the second collection #2 (refer to the dotted line border). The collection configuration table T22 indicates the information amounts within collection and the information amounts between collection of all of the records, the total of the information amounts within collection and the total of the information amounts between collection in each collection, the sum total (24.0) of the information amounts within collection and the sum total (21.1) of the information amounts between collection, and the evaluation value (45.1).

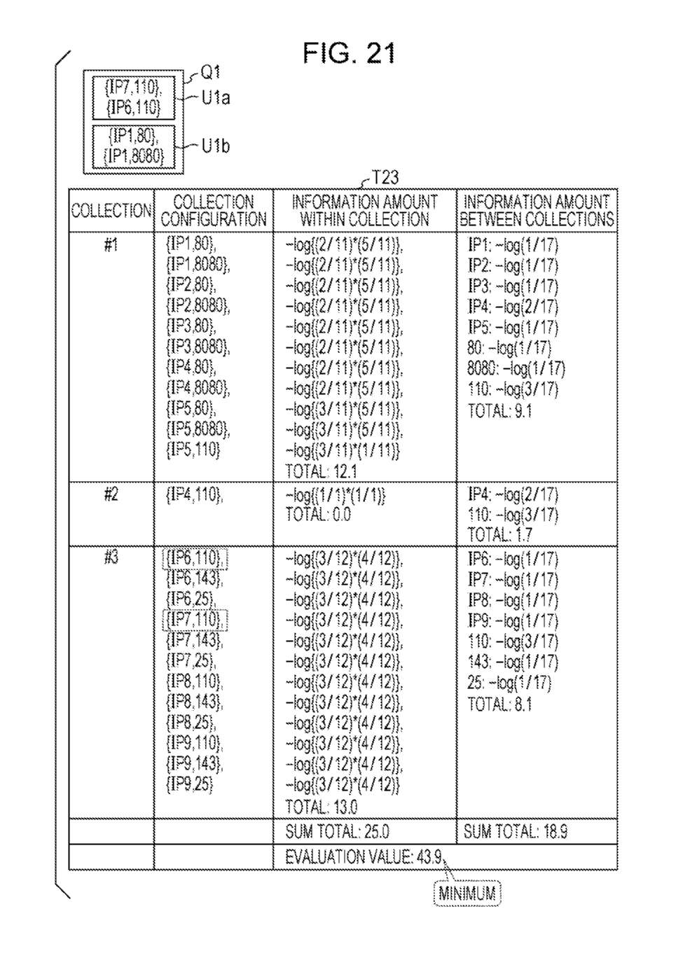

FIG. 21 illustrates a collection configuration table T23 when the record set rg (the collection U1a) is rearranged into the third collection #3 (refer to the dotted line border). The collection configuration table T23 indicates the information amounts within collection and the information amounts between collection of all of the records, the total of the information amounts within collection and the total of the information amounts between collection in each collection, the sum total (25.0) of the information amounts within collection and the sum total (18.9) of the information amounts between collection, and the evaluation value (43.9).

As illustrated in FIGS. 19 to 21, the rearrangement section 112d calculates the information amounts within collection and the information amounts between collection of all of the records, the total of the information amounts within collection and the total of the information amounts between collection in each collection, the sum total of the information amounts within collection and the sum total of the information amounts between collection, and the evaluation value and stores the values in the RAM 102.

As illustrated in FIG. 21, the evaluation value when the record set rg (the collection U1a) is rearranged into the third collection #3, is the most favorable (the minimum). This minimum evaluation value is indicated using the “Minimum” balloon in FIG. 21. Accordingly, the rearrangement section 112d rearranges the record set rg (the collection U1a) into the third collection #3 (S7). The collection configuration column of the collection configuration table T23 of FIG. 21 corresponds to the collection configuration column of the collection configuration table T2 of FIG. 13.

The rearrangement section 112d removes the record set rg (the collection U1a) from the record assembly Q1 (S8). Since the record assembly Q1 from which the record set rg (the collection U1a) has been removed, includes the collection U1b, the record assembly Q1 is not an empty assembly (NO in S9). Accordingly, the rearrangement section 112d determines NO in S9, and the process moves to S4.

Among the record assembly Q1 after removal, the rearrangement section 112d acquires a record set rg for which the improvement quantity of the evaluation value is largest (S4).

In the example of FIG. 16, the largest improvement quantity of the evaluation value is −0.2, and the records that belong to the collection Up11 (the collection U1b) when the improvement quantity of the evaluation value is largest are the records {IP1,80} and {IP1,8080}.

Accordingly, among the record assembly Q1, the record set rg for which the improvement quantity of the evaluation value is largest, is the records (the collection U1b) that belong to the collection Up11 (the collection U1b) when the largest improvement quantity of the evaluation value (−0.2) is attained. Accordingly, the rearrangement section 112d acquires the record set rg (the collection U1b) (S4).

The calculation section 112b calculates a first evaluation value e1 and a second evaluation value e2 based on the record set rg (the collection U1b) that was acquired in S4 (S5). Further, the determination section 112c determines the effectiveness of the record set rg that was acquired in S4 (S6).

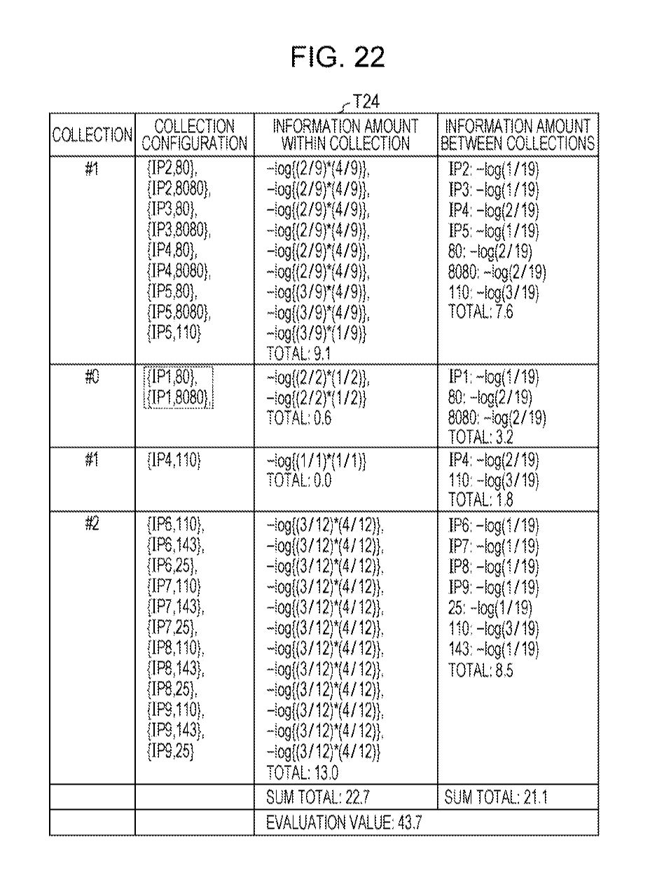

FIG. 22 is a drawing that describes the collection configuration table T24 of a case in which the record set rg is rearranged into the virtual collection #0 (refer to the dotted line border). More specifically, in the collection configuration table that is illustrated in FIG. 22, the records {IP1,80} and {IP1,8080} are rearranged into the virtual collection #0 from the first collection #1. For example, the calculation section 112b refers to the collection configuration table T24 that is illustrated in FIG. 22, and calculates the first evaluation value e1 in the same manner as the case that is described in FIG. 14. More specifically, the calculation section 112b calculates 43.7 as the first evaluation value e1.

Next, the calculation section 112b assumes that the records that belong to the first collection #1 (the source collection to which the records {IP1,80} and the {IP1,8080} belong) in the collection configuration table T23 that is illustrated in FIG. 21, have been randomly rearranged into any one of the first collection #1 and the virtual collection #0. Further, the calculation section 112b calculates an evaluation value (the second evaluation value e2) in this case (S5).

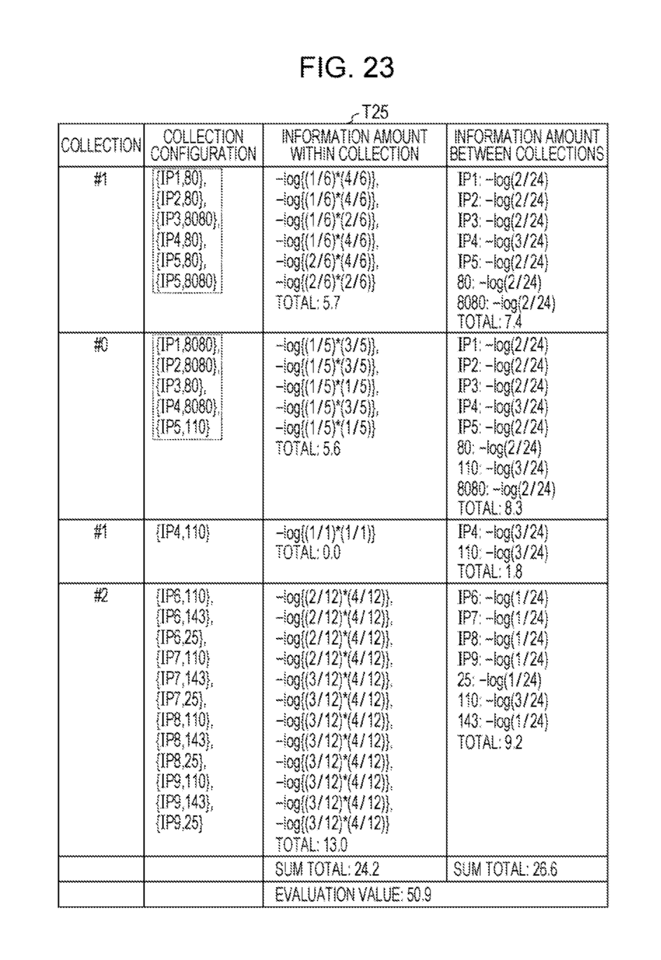

FIG. 23 is a drawing that describes the collection configuration table T25 when a record that is arranged in the first collection #1 in the collection configuration table T23, is randomly arranged into any one of the first collection #1 and the virtual collection #0 (refer to the dotted line border) in the collection configuration table T23 that is illustrated in FIG. 21. More specifically, in the collection configuration table that is illustrated in FIG. 23, the records {IP1,80}, {IP2,80}, {IP3,8080}, {IP4,80}, {IP5,80}, and {IP5,8080} are arranged into the first collection #1. In addition, in the collection configuration table that is illustrated in FIG. 18, the records {IP1,8080}, {IP2,8080}, {IP3,80}, {IP4,8080}, and {IP5,110} are arranged into the virtual collection #0. For example, the calculation section 112b refers to the collection configuration table T25 that is illustrated in FIG. 23, and calculates the second evaluation value e2 in the same manner as the case that is described in FIG. 14. More specifically, the calculation section 112b calculates 50.9 as the second evaluation value e2.

Thereafter, in a case in which the above-mentioned Formula 2 is established, the determination section 112c determines that the record set rg that is acquired in S4 is an effective record set rg (S6).

More specifically, in a case in which ε is 0.1, the left side is 35.8, and the right side is 43.9 (refer to FIG. 21). Accordingly, in this case, the determination section 112c determines that Formula 2 has been established, and determines that the record set rg is effective (YES in S6).

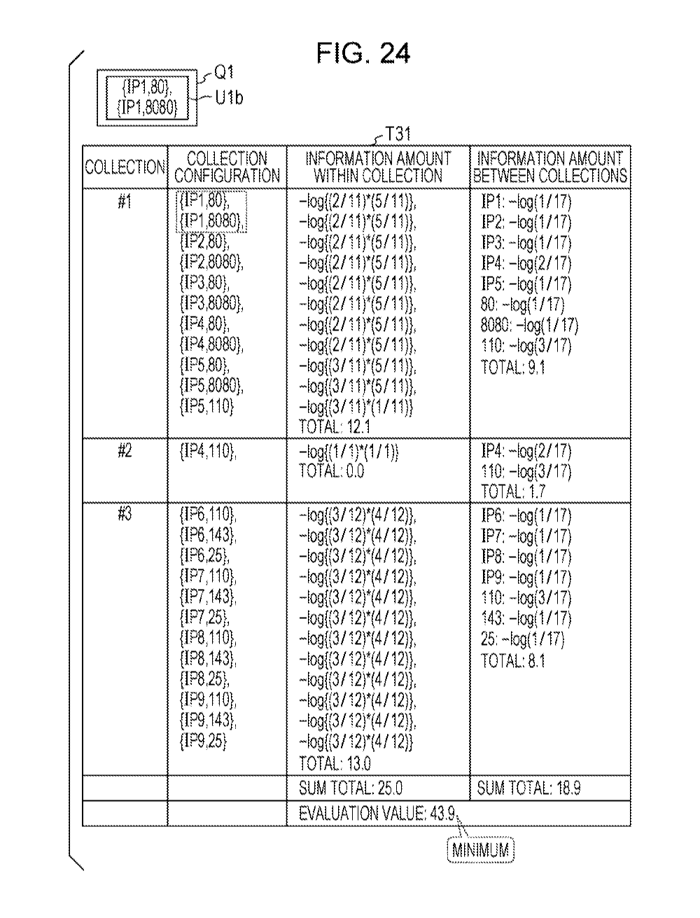

The rearrangement section 112d rearranges the record set rg into a single collection for which the evaluation value is most favorable when the record set rg (the collection U1b) is rearranged into any collection of the first collection #1 to the third collection #3 (S7). This rearrangement will be described with respect to FIGS. 24 to 26. In the abovementioned manner, the rearrangement section 112d calculates each value in a case in which the record set rg (the collection U1b) is rearranged into the first collection #1 to the third collection #3.

FIG. 24 illustrates a collection configuration table T31 when the record set rg (the collection U1b) is rearranged into the first collection #1 (refer to the dotted line border). The collection configuration table T31 indicates the information amounts within collection and the information amounts between collection of all of the records, the total of the information amounts within collection and the total of the information amounts between collection in each collection, the sum total (25.0) of the information amounts within collection and the sum total (18.9) of the information amounts between collection, and the evaluation value (43.9).

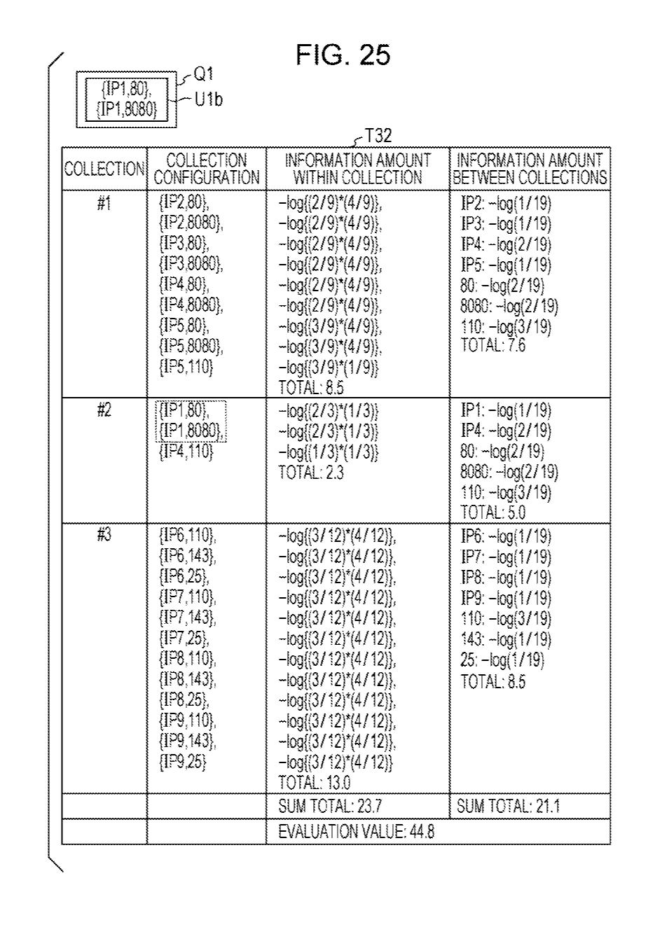

FIG. 25 illustrates a collection configuration table T32 when the record set rg (the collection U1b) is rearranged into the second collection #2 (refer to the dotted line border). The collection configuration table T32 indicates the information amounts within collection and the information amounts between collection of all of the records, the total of the information amounts within collection and the total of the information amounts between collection in each collection, the sum total (23.7) of the information amounts within collection and the sum total (21.1) of the information amounts between collection, and the evaluation value (44.8).

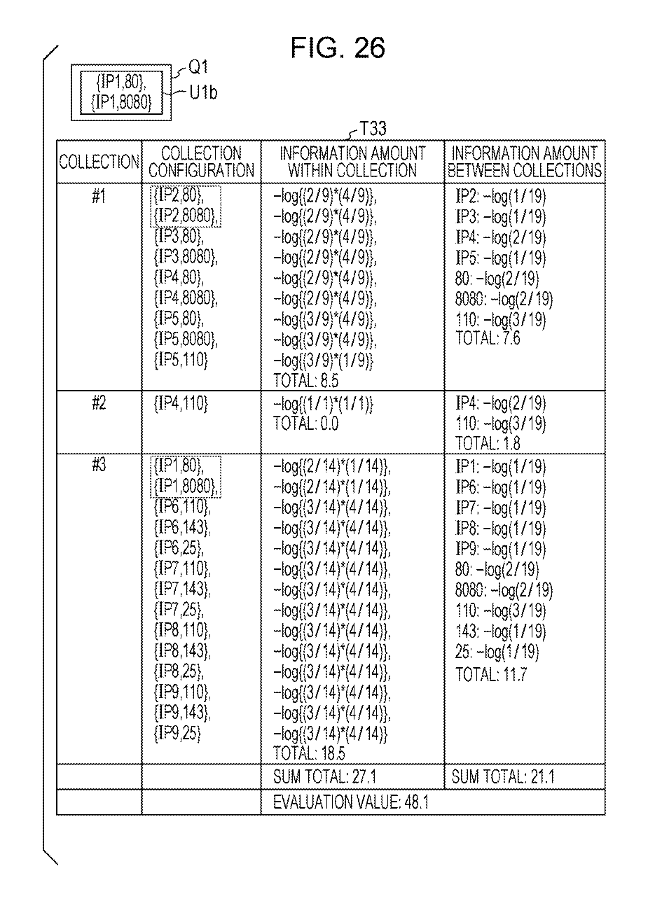

FIG. 26 illustrates a collection configuration table T33 when the record set rg (the collection U1b) is rearranged into the third collection #3 (refer to the dotted line border). The collection configuration table T33 indicates the information amounts within collection and the information amounts between collection of all of the records, the total of the information amounts within collection and the total of the information amounts between collection in each collection, the sum total (27.1) of the information amounts within collection and the sum total (21.1) of the information amounts between collection, and the evaluation value (48.1).

As shown in FIGS. 24 to 26, the rearrangement section 112d calculates the information amounts within collection and the information amounts between collection of all of the records, the total of the information amounts within collection and the total of the information amounts between collection in each collection, the sum total of the information amounts within collection and the sum total of the information amounts between collection, and the evaluation value and stores the values in the RAM 102.

As illustrated in FIG. 24, the evaluation value when the record set rg (the collection U1b) is rearranged into the first collection #1, is the most favorable (the minimum). This minimum evaluation value is indicated using the “Minimum” balloon in FIG. 24. Accordingly, the rearrangement section 112d rearranges the record set rg (the collection U1b) into the first collection #1 (S7). The collection configuration column of the collection configuration table T31 of FIG. 24 corresponds to the collection configuration column of the collection configuration table T3 of FIG. 13.

The rearrangement section 112d removes the record set rg (the collection U1b) from the record assembly Q1 (S8). The record assembly Q1 from which the record set rg (the collection U1b) has been removed, is an empty assembly (YES in S9). Accordingly, the rearrangement section 112d determines YES in S9, and the process moves to S10. The rearrangement section 112d calculates an evaluation value e after rearrangement which is 43.9 (S10).

The evaluation value e, 43.9, after rearrangement is less than the source evaluation value e_pre (refer to the evaluation value 48.3 in FIG. 14) (NO in S11), the rearrangement section 112d moves to S12.

The rearrangement section 112d determines whether or not the steps of S2 to S11 have been repeated R times (for example, one time). In the examples of FIGS. 14 to 26, since the steps of S2 to S11 have been executed one time, the rearrangement section 112d determines YES in S12, and the process is finished.

The rearrangement section 112d inputs the collection configuration table T31 of FIG. 26 that illustrates collections after rearrangement, to the output section 113. The output section 113 outputs a collection identifier that is stored in the collection column that is illustrated in the collection configuration table T31 of FIG. 26, and records that belong to a collection that is identified by the collection identifier, to an output device. That is, the rearrangement section 112d outputs a collection identifier that is stored in the collection column that is illustrated in the collection configuration table T31 of FIG. 26, and classified records that are stored in the collection configuration column, to an output device.

In the abovementioned manner, the data classification apparatus 1 of the present embodiment executes a classification process of data classification apparatus of the present embodiment that takes the information amounts between collection into consideration in addition to just the information amounts within collection. As a result of this, it is possible to classify discrete data into optimum collections that may easily achieve the object of an analyst.

In addition, the data classification apparatus 1 of the present embodiment selects one or more records for which it is possible to estimate that the reduction quantities in the evaluation values thereof will be largest, and sets the selected one or more records as records for rearrangement (refer to S36 in FIG. 12, and FIGS. 15 and 16).

Meanwhile, it is also possible to consider a method in which a record set to be rearranged is created at random, and the created record set is rearranged into a collection (for example, the first collection #1 to the third collection #3) in which the evaluation value is smallest. However, the execution of such a method on a large number of records is unrealistic since the computational amount is colossal. In contrast to this, the data classification apparatus 1 of the present embodiment selects one or more records for which it is possible to estimate that the reduction quantities in the evaluation values thereof will be largest, and thereafter, rearranges the selected one or more records so that the evaluation value is the smallest. Accordingly, it is possible to suppress increases in the computational amount, and therefore, it is possible to reduce a processing load.

In addition, the data classification apparatus 1 of the present embodiment may select a plurality of records for rearrangement. Therefore, it is possible to classify so that the number of identical variable values (the shared count) that belong to different collections is as small as possible.

For example, when a record set that includes a plurality of records is amalgamated into a certain collection, in a case of classifying discrete data using the method that was described using FIGS. 2 to 7, it is no longer possible to suppress increases in the number of identical variable values that belong to different collections. As a result of this, it is difficult to arrange the record set that belongs to the certain collection into another collection. However, since it is possible to select a plurality of records for rearrangement, it is possible to suppress increases in the number of identical variable values.

Furthermore, the data classification apparatus 1 of the present embodiment determines whether or not a record set in which the evaluation value is impossible to be improved as a result of being rearranged, may improve the evaluation value as a result of rearrangement thereof being continued. As a result of this, for example, the data classification apparatus 1 may continue the rearrangement of the record set even in a case in which there is not a collection that may improve the evaluation value as a result of rearrangement of the record set, in collections into which it is possible to rearrange the record set.

In addition, the data classification apparatus 1 does not perform rearrangement for record sets in which the evaluation value is impossible to be improved as a result of being rearranged, and in which the evaluation value is impossible to be improved on a long-term basis even when rearrangement is continued. As a result of this, the data classification apparatus 1 may perform classification of a plurality of records that are included in discrete data efficiently.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data classification apparatus comprising:
a memory that stores a plurality of records, and
a processor configured to
acquire data including the plurality of records, each of the plurality of records including a plurality of types of variable values,
generate a plurality of groups in which each of the plurality of records included in the acquired data is arranged,
calculate a first evaluation value and a second evaluation value, the first evaluation value being calculated based on an arrangement status of the plurality of records when a first record arranged in a first group included in the plurality of groups is rearranged into a second group which is a new group that is not included in the plurality of groups, and the second evaluation value being calculated based on an arrangement status of the plurality of records when each record that is arranged in the first group is rearranged into either the first group or the second group,
determine whether or not to rearrange the first record based on the first evaluation value and the second evaluation value, and
rearrange the first record in a case in which it is determined that the first record is to be rearranged.

2. The data classification apparatus according to claim 1,
wherein the processor is further configured to
calculates a first subtracted value by subtracting the first evaluation value from the second evaluation value, and
performs determination that rearranges the first record in a case in which a second subtracted value, which is calculated by subtracting the first subtracted value from the first evaluation value, is smaller than a third evaluation value based on a current arrangement status of the plurality of records.

3. The data classification apparatus according to claim 2,
wherein the processor is further configured to
calculates the second subtracted value by subtracting, from the first evaluation value, a value obtained by multiplying a weighting coefficient by the value of the first subtracted value.

4. The data classification apparatus according to claim 1,
wherein the processor is further configured to
calculate, when the first record is rearranged into the second group, the first evaluation value by adding a sum of the inverses of the occurrence probabilities and a sum of the common values, the inverses of the occurrence probabilities being calculated for each of the plurality of records by each group that includes the plurality of groups, the common values being calculated, for each of the variable values, based on the number of groups among the plurality of groups and the second group that respectively include the variable values and the number of types of the variable values that are included in any of the groups among the plurality of groups and the second group.

5. The data classification apparatus according to claim 1,
wherein the processor is further configured to
calculate, when a record arranged in the first group is rearranged into either the first group or the second group, the second evaluation value by adding a sum of the inverses of the occurrence probabilities and a sum of the common values, the inverses of the occurrence probabilities being calculated for each of the plurality of records by each group that includes the plurality of groups, the common values being calculated, for each of the variable values, based on the number of groups among the plurality of groups and the second group that respectively include the variable values and the number of types of the variable values that are included in any of the groups among the plurality of groups and the second group.

6. The data classification apparatus according to claim 4,
wherein the processor is further configured to
calculate the first and second evaluation values by calculating a logarithmic total of the calculated inverses of the occurrence probabilities as a first total, calculating a logarithmic total of the calculated common values as a second total, and adding the first total and the second total.

7. The data classification apparatus according to claim 1,
wherein the processor is further configured to
calculate a third evaluation value by calculating the inverse of the occurrence probability for each of the plurality of groups and each of the plurality of records, calculating a common value based on the number of groups among the plurality of groups that respectively include the variable values, and the number of types of the variable values that are included in any of the groups among the plurality of groups, for each of the variable values, and adding a sum of the calculated inverses of the occurrence probabilities and a sum of the calculated common values.

8. The data classification apparatus according to claim 1,
wherein the processor is further configured to
perform generation of the plurality of groups by generating Na groups by selecting Na records at random from the plurality of records so that there are few shared number of variable values that are included, and respectively arranging records other than the Na records among the plurality of records into the Na groups so that the occurrence probability of each of the plurality of groups and each of the records is high, Na being an integer of 2 or more.

9. The data classification apparatus according to claim 2,
wherein the processor is further configured to
rearrange the first record into a group, among the plurality of groups, in which a reduction quantity of a fourth evaluation value with respect to the third evaluation value is greatest on the basis of the arrangement status when the first record is rearranged.

10. A data classification method comprising:
acquiring, by a computer, data including a plurality of records, which respectively include a plurality of types of variable values; and
classifying a plurality of records, which are included in the acquired data,
wherein, in the classifying,
a plurality of groups in which the plurality of records are respectively arranged, are generated,
a first evaluation value based on an arrangement status of the plurality of records is calculated in a case in which a first record, which is arranged in a first group that is included in the plurality of groups, is rearranged into a second group, which is a new group that is not included in the plurality of groups, and a second evaluation value based on an arrangement status of the plurality of records is calculated in a case in which each record that is arranged in the first group is rearranged into either the first group or the second group,
determination of whether or not to rearrange the first record is performed based on the first evaluation value and the second evaluation value, and
rearrangement of the first record is performed in a case in which it is determined that the first record is to be rearranged.

11. A non-transitory computer-readable recording medium having stored therein a program that causes a computer to execute a process for data classification, the process comprising:
acquiring data including a plurality of records, which respectively include a plurality of types of variable values; and
classifying a plurality of records, which are included in the acquired data,
wherein, in the classifying,
a plurality of groups in which the plurality of records are respectively arranged, are generated,
a first evaluation value based on an arrangement status of the plurality of records is calculated in a case in which a first record, which is arranged in a first group that is included in the plurality of groups, is rearranged into a second group, which is a new group that is not included in the plurality of groups, and a second evaluation value based on an arrangement status of the plurality of records is calculated in a case in which each record that is arranged in the first group is rearranged into either the first group or the second group,
determination of whether or not to rearrange the first record is performed based on the first evaluation value and the second evaluation value, and
rearrangement of the first record is performed in a case in which it is determined that the first record is to be rearranged.
